(19) United States
(12) Patent Application Publication
(10) Pub. No.: US 2026/0099370 A1
(43) Pub. Date: Apr. 9, 2026

(54) Method and System for Energy Aware Wireless Network Intelligence Scaling

(71) Applicant: Northeastern University, Boston, MA (US)

(72) Inventors: Tommaso MELODIA, Newton, MA (US); Salvatore D'Oro, Brookline, MA (US); Leonardo Bonati, Boston, MA (US); Michele Polese, Cambridge, MA (US)

(21) Appl. No.: 18/897,678

(22) Filed: Sep. 26, 2024

Related U.S. Application Data
(60) Provisional application No. 63/540,647, filed on Sep. 26, 2023.

(51) Int. Cl. G06F 9/50

(52) U.S. Cl. CPC G06F 9/5027

(57) ABSTRACT

Provided herein are methods and systems for energy aware wireless network intelligence scaling in an O-RAN open radio access network including receiving, at an energy aware scaling component deployed on a non-RT RIC of the O-RAN, a set of requests including a requested selection of apps for deployment on server resources of the O-RAN, each app having a maximum tolerable inference time, detecting a set of available server resources, determining an estimated inference time for each of the requested selection of apps, generating a deployment and instantiation policy for executing the requested selection of apps within the associated maximum tolerable inference times using the set of available server resources, the instantiation policy optimized to at least one of minimize energy consumption; maximize profitability, or both, and deploying and instantiating the requested selection of apps in the set of available server resources to satisfy the set of requests.

### CROSS REFERENCE TO RELATED APPLICATIONS

This application claims benefit under 35 U.S.C. § 119(e) of U.S. Provisional Application No. 63/540,647, filed on 26 Sep. 2023, entitled “METHOD AND SYSTEM FOR ENERGY AWARE WIRELESS NETWORK INTELLIGENCE SCALING,” the entirety of which is incorporated by reference herein.

### STATEMENT REGARDING FEDERALLY SPONSORED RESEARCH OR DEVELOPMENT

This invention was made with government support under Grant No. 25-60-IF002 awarded by the National Institute of Standards and Technology and with governmental support under Grant No. W911NF-19-2-0221 awarded by the Army Research Office (MURI). The government has certain rights in the invention.

### BACKGROUND

The need for more flexible, energy-efficient, and cost-effective cellular networks—capable at the same time of delivering and guaranteeing high data rates and low latency—is driving the telco ecosystem toward Radio Access Network (RAN) cloudification. The shift leverages the principles of virtualization and softwarization, concepts deeply ingrained in cloud computing and internetworking fields via Software Defined Networking (SDN) [1] and Network Functions Virtualization (NFV). These principles enable the design, development, and deployment of cellular networks with superior flexibility, which can be effectively monitored, controlled, optimized, upgraded, and reconfigured in real time via software.

This ongoing industry transformation has led to the Open RAN paradigm, and the creation of the O-RAN Alliance [2]. O-RAN leverages the principles described above to foster a cloud-based cellular architecture, with interoperable multivendor hardware and software components interconnected via open and standardized interfaces. It also embeds Artificial Intelligence (AI) and Machine Learning (ML) directly into the network to forecast loads, Key Performance Indicators (KPIs) and user mobility, control RAN functionalities and spectrum usage, and classify traffic profiles and identify anomalies, to name a few [2, 3]. To enable flexible 5G/6G networks, O-RAN introduces the concept of RAN Intelligent Controller (RIC), i.e., an abstraction enabling the execution of third-party network functions for AI-based inference and control. RICs are based on micro-services embedding intelligent workloads, called xApps and rApps. O-RAN defines specifically the Near-real-time (near-RT) (hosting xApps) and the non-real-time (non-RT) RICs (hosting rApps) for inference loops up to 1 s and beyond 1 s, respectively. In addition to O-RAN specifications, dApps have been proposed as micro-services for real-time inference (≤10 ms) in the Central Units (CUs)/Distributed Units (DUs) [4]. The advantages of this cloud-based approach are: (i) it enables dynamic reconfiguration of the RAN by instantiating disaggregated RAN functionalities, xApps and rApps on-the-fly to meet current demand and requirements [5-7]; and (ii) it greatly reduces the total cost of ownership (TCO) through cloud infrastructure sharing (i.e., sharing of data centers, servers and network equipment) [8].

However, RAN cloudification comes with possible downsides. First, it expands the compute surface, thus potentially increasing the power consumption of the RAN. Second, implementing intelligent control via micro-services in a cloud environment (called O-Cloud in O-RAN) may not provide tight performance guarantees required to close the control loops in the real, near-real, or non-real timescales. While timing constraints of virtualized RANs have been studied extensively in the literature with respect to the user plane [9-12], how to achieve the same guarantees in the control plane is still an open challenge, especially regarding control loops and decisions made by the RICs. Guaranteeing such constraints in the control plane is necessary to ensure that such decisions are timely and do not become obsolete by the time they are enforced.

Indeed, poorly-managed O-Cloud environments for rApps, xApps, and dApps can easily lead to control deadline violations, as shown in FIGS. 1A-1B. Specifically, FIG. 1A reports (i) the queuing time, i.e., the time needed by the near-RT RIC to de-queue input data from the RAN and feed it to an xApp (x-axis); (ii) the execution time, i.e., the time needed by the xApp to process the input and generate an output (y-axis). FIG. 1B reports the inference time, i.e., the sum of queuing and execution time, with an increasing number of xApp executed on the RIC. The example of FIGS. 1A-1B is based on measurements taken on an O-RAN-compliant near-RT RIC deployed on a Red Hat OpenShift cluster in accordance with the prior art, where xApps with diverse AI workloads are instantiated. The goal is to close the loop within the 1 s near-RT RIC region (shaded areas in FIGS. 1A-1B). In this case, the OpenShift fails to satisfy the control latency guarantees when the number of xApps exceeds 50, which is a conservative estimate if the number of xApps that a near-RT RIC is expected to host when controlling tens or hundreds of base stations [13] is considered.

In the cloud industry, compute resource scaling is an established strategy to cope with the need for extra processing power and is a well-investigated topic in the literature [14-16], with a variety of approaches ranging from heuristic schedulers to predictive and ML-based models [17-24]. However, these solutions focus on ensuring that generic micro-services properly execute on the available compute resources, but do not provide performance guarantees on latency-critical applications. As an example, in a widely used framework like Kubernetes scaling is obtained either by regulating the amount of resources allocated to each service, or by increasing the number of active worker nodes in the compute cluster. However, this approach is based on resource utilization (e.g., CPU, RAM) and not on latency constraints (as described and illustrated herein, CPU/RAM-based scaling alone is unsuitable to ensure timely RAN control) [25]. Previous work has also addressed scaling with deadline constraints, but it considers long-term or stochastic latency metrics and leverage heuristic solutions rather than optimization [17, 26-29]. Moreover, uncontrolled and sub-optimal scaling might unnecessarily utilize excessive resources, thus increasing the energy consumption and costs (capital and operational), making the O-RAN proposition less attractive for network operators [30]. Therefore, it is crucial to explore and understand this complex trade-off between latency and energy consumption.

Dynamic scaling of virtual machines or micro-services has been widely studied in the last decade [14, 15]. When considering scaling with latency guarantees, Singhvi et al. manage application latency with a deadline-aware scheduler in a serverless environment [17]. Mao et al. model virtual workload deadlines and costs, but for long-running applications rather than real, near-real, or non-real time control [26, 27]. Anagnostou et al. consider auto-scaling to meet deadlines for simulation workloads [28]. Das et al. [29] scale resources to meet query deadlines for a relational database, using a token bucket approach. Compared to prior work, this disclosure focuses on tight control timelines, combines energy minimization or profit maximization, and scales resources solving a QCQP based on a detailed model of RAN control workloads.

Open RAN is extending the cloud domain to cellular network functions. Several virtual network function (VNF) scaling solutions have been proposed, but without considering latency guarantees for closed-loop control [31-33]. In the O-RAN context, Ali et al. analyze how to proactively scale resources for VNFs with workloads prediction [34]. D'Oro et al. orchestrate applications deployment, without however considering scaling or energy efficiency [35]. In the user plane, Garcia-Aviles et al. design a framework to preserve synchronization among base stations and users, maximize network throughput, and save resources in the presence of computing capacity shortages [9]. Thaliath et al. [36] proactively scale resources to support network slices. However, these works are more concerned with optimally placing or executing services across the Open RAN infrastructure, rather than on guaranteeing control latency and minimizing energy consumption.

Finally, energy efficiency is a priority for virtualized Open RAN. Prior literature work investigated energy consumption for the RAN—which consumes most of the energy in a cellular system [37]—as well as for VNFs (e.g., core network, multi-access edge computing, and RICs). Ayala-Romero et al. optimize virtualized RAN power consumption, evaluating waveform trade-offs in different signal-to-noise ratio regimes [38]. Pamuklu et al. propose a mixed linear programming problem for energy optimization, mindful of maximum tolerable delays for the data plane of the RAN [39]. Bonati et al. minimize RAN power consumption with dynamic power control orchestrated by a centralized controller [40]. Compared to these works, and to the best of our knowledge, ScalO-RAN is the first framework that optimally combines compute scaling, energy minimization, and timing constraints for RAN control in O-RAN, including an experimental inference characterization for different control workloads, and an experimental prototype.

### SUMMARY

Network virtualization, software-defined infrastructure, and orchestration are pivotal elements in contemporary networks, yielding new vectors for optimization and novel capabilities. In line with these principles, O-RAN presents an avenue to bypass vendor lock-in, circumvent vertical configurations, enable network programmability, and facilitate integrated artificial intelligence (AI) support. Moreover, modern container orchestration frameworks (e.g., Kubernetes, Red Hat OpenShift) simplify the way cellular base stations, as well as the newly introduced RAN Intelligent Controllers (RICs), are deployed, managed, and orchestrated. While this enables cost reduction via infrastructure sharing, it also makes it more challenging to meet O-RAN control latency requirements, especially during peak resource utilization. For instance, the Near-real-time RIC is in charge of executing applications (xApps) that must take control decisions within one second, and the inventors show that container platforms available today fail in guaranteeing such timing constraints. To address this problem, an energy aware wireless network intelligence scaling system (ScalO-RAN) is presented, which is a control framework rooted in optimization and designed as an O-RAN rApp or Service Management and Orchestration (SMO) component that allocates and scales AI-based O-RAN applications (xApps, rApps, and dApps) to: (i) abide by application-specific latency requirements, and (ii) monetize the shared infrastructure while reducing energy consumption. ScalO-RAN is prototyped on an OpenShift cluster with base stations, RIC, and a set of AI-based xApps deployed as micro-services. ScalO-RAN is evaluated both numerically and experimentally. Results show that ScalO-RAN can optimally allocate and distribute O-RAN applications within available computing nodes to accommodate even stringent latency requirements. More importantly, scaling O-RAN applications is shown to be primarily a time-constrained problem rather than a resource-constrained one, where scaling policies must account for stringent inference time of AI applications, and not only on how much resources they consume.

ScalO-RAN is an O-RAN energy aware scaling system to enforce inference time constraints on intelligent applications. Provided herein is a latency model based on a measurement campaign on an OpenShift cluster, a mathematical optimization model, and an O-RAN-compliant prototype. ScalO-RAN was compared with Open-Shift's scaling mechanism, showing that ScalO-RAN is able to deploy O-RAN applications complying with specific latency constraints required by network operators. Results demonstrate that scaling AI solutions in O-RAN systems is not resource-constrained only, but time-constrained in that requirements on the inference time strongly affect how many dApps, xApps and rApps can coexist on the same server.

In one aspect, a method is provided for energy aware wireless network intelligence scaling in an O-RAN open radio access network (RAN). The method includes receiving, at an energy aware scaling Service Management and Orchestration (SMO) component (scaling component) deployed on a non-real-time (non-RT) RAN intelligent controller (RIC) of the O-RAN, a set of requests including a requested selection of apps comprising one or more rApps, xApps, dApps, or combinations thereof, each being a micro-service embedding an intelligent workload, for deployment on one or more server resources of the O-RAN, each rApp, xApp, and dApp having a maximum tolerable inference time associated therewith. The method also includes detecting, in the scaling component, a set of available server resources for executing the requested selection of apps. The method also includes determining an estimated inference time for each of the apps of the requested selection of apps. The method also includes generating, by an optimization engine of the scaling component, a deployment and instantiation policy (instantiation policy) for executing the requested selection of apps within the associated maximum tolerable inference times using the set of available server resources, the instantiation policy optimized to at least one of minimize energy consumption, maximize profitability, or both in connection with executing the requested selection of apps within the associated maximum tolerable inference times. The method also includes deploying and instantiating, by a deployment engine of the scaling component, the requested selection of apps in the set of available server resources according to the instantiation policy to satisfy the set of requests.

In some embodiments, the maximum tolerable inference time for each rApp is 1 s or more. In some embodiments, the maximum tolerable inference time for each xApp is 1 s or less. In some embodiments, the maximum tolerable inference time for each dApp is 10 ms or less. In some embodiments, one or more of the rApps, xApps, and dApps of the requested selection of apps is selected from an app catalog stored in the non-RT RIC. In some embodiments, a descriptor database in communication with the app catalog and the scaling component includes the estimated inference time associated with each of the one or more of the rApps, xApps, and dApps selected from the app catalog. In some embodiments, one or more of the rApps, xApps, and dApps of the requested selection of apps is a new app provided by a request originator, not described in an app catalog stored in the non-RT RIC and not described in a descriptor database in communication with the app catalog and the scaling component. In some embodiments, the step of determining an estimated inference time includes profiling the new app by deploying the new app on an idle worker node of the O-RAN to benchmark the estimated inference time for the new app. In some embodiments, the method also includes storing the estimated inference time for the new app in the descriptor database.

In some embodiments, the step of deploying and instantiating includes deploying and instantiating the rApps for execution in one or more non-RT RICs of the O-RAN. In some embodiments, the step of deploying and instantiating includes deploying and instantiating the xApps for execution in one or more near-RT RICs of the O-RAN. In some embodiments, the step of deploying and instantiating includes deploying and instantiating the dApps for execution in one or more centralized units (CUs) and/or distributed units (DUs) of the O-RAN. In some embodiments, the method also includes receiving, at the scaling component, a report from one or more of the server resources indicating a runtime latency associated therewith. In some embodiments, the method also includes further comprising rejecting, by the optimization engine of the scaling component, any request of the set of requests that cannot be satisfied within the associated maximum tolerable inference time.

In another aspect, a system for energy aware wireless network intelligence scaling in an O-RAN open radio access network (RAN) is provided. The system includes a set of available server resources of the O-RAN. The system also includes an energy aware scaling Service Management and Orchestration (SMO) component (scaling component) deployed in a non-real-time (non-RT) RAN intelligent controller (RIC) of the O-RAN, the scaling component configured to receive a set of requests including a requested selection of apps comprising one or more rApps, xApps, dApps, or combinations thereof, each being a micro-service embedding an intelligent workload, for deployment on one or more of the available server resources, each rApp, xApp, and dApp having a maximum tolerable inference time associated therewith. The system also includes an optimization engine of the scaling component configured to execute instructions stored in the non-RT RIC. The instructions stored in the non-RT RIC, when executed by the optimization engine, cause the scaling component to determine an estimated inference time for each of the apps of the requested selection of apps. The instructions stored in the non-RT RIC, when executed by the optimization engine, also cause the scaling component to generate a deployment and instantiation policy (instantiation policy) for executing the requested selection of apps within the associated maximum tolerable inference times using the set of available server resources, the instantiation policy optimized to at least one of minimize energy consumption; maximize profitability, or both in connection with executing the requested selection of apps within the associated maximum tolerable inference times. The system also includes a deployment engine of the scaling component configured to execute instructions stored in the non-RT RIC that, when executed by the deployment engine, cause the scaling component to deploy and instantiate the requested selection of apps in the set of available server resources according to the instantiation policy to satisfy the set of requests.

In some embodiments, the maximum tolerable inference time for each rApp is 1 s or more. In some embodiments, the maximum tolerable inference time for each xApp is 1 s or less. In some embodiments, the maximum tolerable inference time for each dApp is 10 ms or less. In some embodiments, one or more of the rApps, xApps, and dApps of the requested selection of apps is selected from an app catalog stored in the non-RT RIC. In some embodiments, a descriptor database in communication with the app catalog and the scaling component includes the estimated inference time associated with each of the one or more of the rApps, xApps, and dApps selected from the app catalog. In some embodiments, one or more of the rApps, xApps, and dApps of the requested selection of apps is a new app, not described in an app catalog stored in the non-RT RIC and not described in a descriptor database in communication with the app catalog and the scaling component. In some embodiments, the system also includes an idle worker node of the O-RAN configured to benchmark the estimated inference time for the new app responsive to deployment of the new app to the idle worker node by the deployment engine according to instructions from the optimization engine. In some embodiments, the idle worker node is configured to report the benchmarked estimated inference time for the new app to the scaling component for storage in the descriptor database. In some embodiments, the system also includes one or more Non-Real-Time (non-RT) RICs of the O-RAN configured for deployment and instantiation of at least one of the rApps of the requested selection of apps for execution therein. In some embodiments, the system also includes one or more near-RT RICs of the O-RAN configured for deployment and instantiation of at least one of the xApps of the requested selection of apps for execution therein. In some embodiments, the system also includes one or more centralized units (CUs) and/or distributed units (DUs) of the O-RAN configured for deployment and instantiation of at least one of the dApps of the requested selection of apps for execution therein. In some embodiments, the system also includes combinations of the non-RT RICs, near-RT RICs, and/or CUs and DUs. In some embodiments, the scaling component is configured to receive a report from one or more of the server resources indicating a runtime latency associated therewith. In some embodiments, the optimization engine of the scaling component configured to execute instructions stored in the non-RT RIC that, when executed by the optimization engine, cause the scaling component to reject any request of the set of requests that cannot be satisfied within the associated maximum tolerable inference time.

Additional features and aspects of the technology include the following:

1. A method for energy aware wireless network intelligence scaling in an O-RAN open radio access network (RAN) comprising:
receiving, at an energy aware scaling Service Management and Orchestration (SMO) component (scaling component) deployed on a non-real-time (non-RT) RAN intelligent controller (RIC) of the O-RAN, a set of requests including a requested selection of apps comprising one or more rApps, xApps, dApps, or combinations thereof, each being a micro-service embedding an intelligent workload, for deployment on one or more server resources of the O-RAN, each rApp, xApp, and dApp having a maximum tolerable inference time associated therewith;
detecting, in the scaling component, a set of available server resources for executing the requested selection of apps;
determining an estimated inference time for each of the apps of the requested selection of apps;
generating, by an optimization engine of the scaling component, a deployment and instantiation policy (instantiation policy) for executing the requested selection of apps within the associated maximum tolerable inference times using the set of available server resources, the instantiation policy optimized to at least one of minimize energy consumption, maximize profitability, or both in connection with executing the requested selection of apps within the associated maximum tolerable inference times; and
deploying and instantiating, by a deployment engine of the scaling component, the requested selection of apps in the set of available server resources according to the instantiation policy to satisfy the set of requests.
   2. The method of feature 1, wherein:
the maximum tolerable inference time for each rApp is 1 s or more;
the maximum tolerable inference time for each xApp is 1 s or less; and
the maximum tolerable inference time for each dApp is 10 ms or less.
   3. The method of any of features 1-2, wherein one or more of the rApps, xApps, and dApps of the requested selection of apps is selected from an app catalog stored in the non-RT RIC.
   4. The method of feature 3, wherein a descriptor database in communication with the app catalog and the scaling component includes the estimated inference time associated with each of the one or more of the rApps, xApps, and dApps selected from the app catalog.
   5. The method of any of features 1-4, wherein one or more of the rApps, xApps, and dApps of the requested selection of apps is a new app provided by a request originator, not described in an app catalog stored in the non-RT RIC and not described in a descriptor database in communication with the app catalog and the scaling component.
   6. The method of feature 5, the step of determining an estimated inference time further comprising profiling the new app by deploying the new app on an idle worker node of the O-RAN to benchmark the estimated inference time for the new app.
   7. The method of feature 6, further comprising storing the estimated inference time for the new app in the descriptor database.
   8. The method of any of features 1-7, wherein the step of deploying and instantiating further comprises:
deploying and instantiating the rApps for execution in one or more non-RT RICs of the O-RAN;
deploying and instantiating the xApps for execution in one or more near-RT RICs of the O-RAN; and
deploying and instantiating the dApps for execution in one or more centralized units (CUs) and/or distributed units (DUs) of the O-RAN.
   9. The method of any of features 1-8, further comprising receiving, at the scaling component, a report from one or more of the server resources indicating a runtime latency associated therewith.
   10. The method of any of features 1-9, further comprising rejecting, by the optimization engine of the scaling component, any request of the set of requests that cannot be satisfied within the associated maximum tolerable inference time.
   11. A system for energy aware wireless network intelligence scaling in an O-RAN open radio access network (RAN) comprising:
a set of available server resources of the O-RAN;
an energy aware scaling Service Management and Orchestration (SMO) component (scaling component) deployed in a non-real-time (non-RT) RAN intelligent controller (RIC) of the O-RAN, the scaling component configured to receive a set of requests including a requested selection of apps comprising one or more rApps, xApps, dApps, or combinations thereof, each being a micro-service embedding an intelligent workload, for deployment on one or more of the available server resources, each rApp, xApp, and dApp having a maximum tolerable inference time associated therewith; and
an optimization engine of the scaling component configured to execute instructions stored in the non-RT RIC that, when executed by the optimization engine, cause the scaling component to:
   determine an estimated inference time for each of the apps of the requested selection of apps; and
   generate a deployment and instantiation policy (instantiation policy) for executing the requested selection of apps within the associated maximum tolerable inference times using the set of available server resources, the instantiation policy optimized to at least one of minimize energy consumption; maximize profitability, or both in connection with executing the requested selection of apps within the associated maximum tolerable inference times; and
a deployment engine of the scaling component configured to execute instructions stored in the non-RT RIC that, when executed by the deployment engine, cause the scaling component to deploy and instantiate the requested selection of apps in the set of available server resources according to the instantiation policy to satisfy the set of requests.
   12. The system of feature 11, wherein:
the maximum tolerable inference time for each rApp is 1 s or more;
the maximum tolerable inference time for each xApp is 1 s or less; and
the maximum tolerable inference time for each dApp is 10 ms or less.
   13. The system of any of features 11-12, wherein one or more of the rApps, xApps, and dApps of the requested selection of apps is selected from an app catalog stored in the non-RT RIC.
   14. The system of feature 13, wherein a descriptor database in communication with the app catalog and the scaling component includes the estimated inference time associated with each of the one or more of the rApps, xApps, and dApps selected from the app catalog.
   15. The system of any of features 11-14, wherein one or more of the rApps, xApps, and dApps of the requested selection of apps is a new app provided by a request originator, not described in an app catalog stored in the non-RT RIC and not described in a descriptor database in communication with the app catalog and the scaling component.
   16. The system of feature 15, further comprising an idle worker node of the O-RAN configured to benchmark the estimated inference time for the new app responsive to deployment of the new app to the idle worker node by the deployment engine according to instructions from the optimization engine.
   17. The system of feature 16, wherein the idle worker node is configured to report the benchmarked estimated inference time for the new app to the scaling component for storage in the descriptor database.
   18. The system of any of features 11-17, further comprising:
one or more Non-Real-Time (non-RT) RICs of the O-RAN configured for deployment and instantiation of at least one of the rApps of the requested selection of apps for execution therein;
one or more near-RT RICs of the O-RAN configured for deployment and instantiation of at least one of the xApps of the requested selection of apps for execution therein;
one or more centralized units (CUs) and/or distributed units (DUs) of the O-RAN configured for deployment and instantiation of at least one of the dApps of the requested selection of apps for execution therein; or
combinations thereof.
   19. The system of any of features 11-18, the scaling component configured to receive a report from one or more of the server resources indicating a runtime latency associated therewith.
   20. The system of any of features 11-19, the optimization engine of the scaling component configured to execute instructions stored in the non-RT RIC that, when executed by the optimization engine, cause the scaling component to reject any request of the set of requests that cannot be satisfied within the associated maximum tolerable inference time.

### BRIEF DESCRIPTION OF THE DRAWINGS

FIG. 1A is a plot illustrating execution time (s) vs. queuing time (s) for different numbers of xApps in accordance with the prior art.

FIG. 1B is a plot illustrating inference time vs. number of xApps. Shaded areas represent the 1 s maximum latency threshold for xApps on a near real-time RAN intelligent controller (near-RT RIC) in accordance with the prior art.

FIG. 2 is a system schematic illustrating an O-RAN architecture incorporating ScalO-RAN.

FIG. 3 is a functional flow diagram illustrating a ScalO-RAN prototype implemented within a customized OpenShift cluster.

FIG. 4A is a plot illustrating inference time vs. percent CPU usage for different numbers of xApps.

FIG. 4B is a plot illustrating inference time vs. percent RAM usage for different numbers of xApps.

FIG. 5A illustrates execution time vs. queuing time for different numbers of xApps running convolutional neural network (CNN) models.

FIG. 5B illustrates inference time vs. number of xApps for different numbers of xApps running CNN models. ⊗ represents the break point of the piecewise linearization functions.

FIG. 5C illustrates execution time vs. queuing time for different numbers of xApps running long short-term memory (LSTM) models.

FIG. 5D illustrates inference time vs. number of xApps for different numbers of xApps running LSTM models. ⊗ represents the break point of the piecewise linearization functions.

FIG. 5E illustrates execution time vs. queuing time for different numbers of xApps running long deep reinforcement learning (DRL) models.

FIG. 5F illustrates inference time vs. number of xApps for different numbers of xApps running DRL models. ⊗ represents the break point of the piecewise linearization functions.

FIG. 6A illustrates scalability by plotting computation time (ms) v. number of requested instances (I) for varying numbers of servers (S). The solid lines illustrate an optimal solution and the dashed lines illustrate early stopping.

FIG. 6B illustrates energy analysis by plotting energy (kJ) v. number of requested instances (I) for varying numbers of servers (S). The solid lines illustrate an optimal solution and the dashed lines illustrate early stopping.

FIG. 7A illustrates request acceptance ratios v. number of requested instances (I) for varying numbers of servers (S). The solid lines illustrate an optimal solution and the dashed lines illustrate early stopping.

FIG. 7B illustrates server activation ratios v. number of requested instances (I) for varying numbers of servers (S). The solid lines illustrate an optimal solution and the dashed lines illustrate early stopping.

FIG. 8 illustrates probabilities of a server to host a request having a prescribed inference time profile (RT, near-RT, non-RT) for varying numbers of servers (S) by plotting Application Presence (probability of hosting) v. number of requested instances (I) for 2, 10, and 40 servers (S=2, S=10, S=40).

FIG. 9 illustrates probabilities that requests having a prescribed inference time profile (RT, near-RT, non-RT) for varying numbers of servers (S) by plotting Coexistence Factor (probability of coexistence) v. number of requested instances (I) for 2, 10, and 40 servers (S=2, S=10, S=40).

FIG. 10A illustrates request acceptance ratios v. number of requested instances (I) for 10 servers (S=10) for O-RAN networks implementing ScalO-RAN, conventional load balancing, and no scaling.

FIG. 10B illustrates server activation ratios v. number of requested instances (I) for 10 servers (S=10) for O-RAN networks implementing ScalO-RAN, conventional load balancing, and no scaling.

FIG. 10C illustrates energy (kJ) v. number of requested instances (I) for 10 servers (S=10) for O-RAN networks implementing ScalO-RAN, conventional load balancing, and no scaling.

FIG. 10D illustrates latency (s) v. number of requested instances (I) for 10 servers (S=10) for O-RAN networks implementing ScalO-RAN, conventional load balancing, and no scaling.

FIG. 11A illustrates a comparison of RAM utilization over time for O-RAN networks implementing both ScalO-RAN and OpenShift by plotting RAM (%) v. time (s) for each system.

FIG. 11B illustrates CPU utilization over time for O-RAN networks implementing both ScalO-RAN and OpenShift by plotting CPU (%) v. time (s) for each system.

FIG. 12A illustrates an evolution of inference time (s) v. time for O-RAN networks implementing ScalO-RAN.

FIG. 12B illustrates an evolution of inference time (s) v. time for O-RAN networks implementing OpenShift.

FIG. 13A illustrates a cumulative distribution function (CDF) of inference time for 0-RAN networks implementing both ScalO-RAN and OpenShift.

FIG. 13B illustrates a boxplot of inference time for O-RAN networks implementing both ScalO-RAN and OpenShift.

### DETAILED DESCRIPTION

Provided herein are methods and systems for energy aware wireless network intelligence scaling. An objective of such energy aware wireless network intelligence scaling methods and systems is to optimize the trade-off between latency and energy consumption, and specifically to provide an optimization framework for scaling compute resources in a cloud computing cluster (O-Cloud) of an O-RAN open radio access network that is (i) aware of specific O-RAN application requirements; and (ii) satisfies inference constraints while minimizing energy consumption.

In this regard, at least the following are provided herein:

1. An energy aware wireless network intelligence scaling system, hereinafter referred to as “ScalO-RAN,” a tunable auto-scaling framework for O-RAN systems, capable of managing AI-based xApps, rApps, and dApps on shared computing clusters with latency guarantees while considering important aspects such as profit and energy consumption.

2. An extensive data collection campaign on the O-RAN Software Community (OSC) near real-time RAN intelligent controller (near-RT RIC) deployed on an OpenShift cluster to evaluate how resource sharing and scaling affect inference times of AI-based O-RAN applications. These measurements are leveraged to derive a data-driven latency model that is used by ScalO-RAN to efficiently instantiate xApps, rApps, and dApps to satisfy application-specific latency requirements.

3. Formulation of the latency-constrained instantiation and scaling problem as a Quadratically Constrained Quadratic Problem (QCQP) which is proven to be NP-hard. The problem is solved via branch-and-bound and ScalO-RAN's effectiveness is evaluated via simulations. The results show that scaling AI O-RAN applications is a time-constrained problem where congestion is not measured on how fast AI can produce outputs to guarantee continuous decision-making at diverse time scales, and not simply on how many resources are consumed.

4. ScalO-RAN prototyped as an rApp, and an extensive experimental campaign on an O-RAN-compliant testbed. Results show that ScalO-RAN can effectively perform instantiation and scaling tasks while guaranteeing desired application-specific latency requirements.

### ScalO-RAN Architecture and Prototype

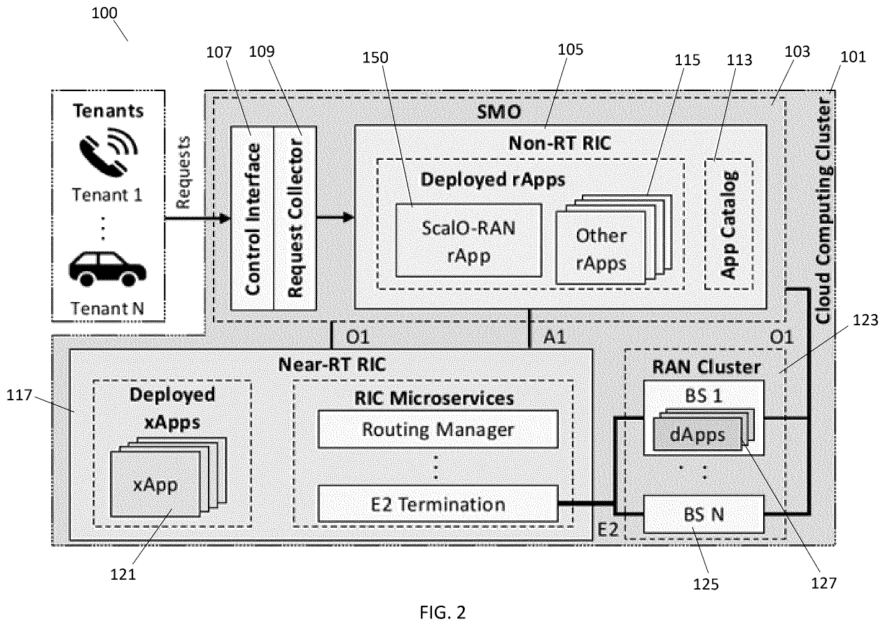

FIG. 2 illustrates an energy aware O-RAN network 100 having ScalO-RAN 150 integrated with the O-RAN architecture via an rApp. It is noted, however, that, although ScalO-RAN is shown and described herein in the context of being prototyped and tested as an rApp, ScalO-RAN 150 need not be an rApp and can be implemented as any suitable Service Management and Orchestration (SMO) 103 component in accordance with various embodiments.

As shown, a set of tenants T (e.g., network operators) interface with a control interface 107 in the SMO 103 to submit their request to deploy AI-based O-RAN applications. Requests are collected by a request collector 109, also hosted in the SMO 103, and forwarded to the ScalO-RAN 150 component (e.g., an rApp as shown and prototyped) on a time-slotted basis. Specifically, while tenants can submit requests at any given time, the request collector 109 forwards queued requests every T seconds. T is a tunable parameter that must be large enough to account for the time needed by ScalO-RAN optimization engine 151 to compute a solution, and the time needed to instantiate rApps 115, xApps 121, and dApps, 127 requested by tenants. After receiving these requests, ScalO-RAN 150 computes an optimal instantiation and scaling policy to accommodate them, while making sure that demand and temporal constraints are satisfied. This optimization process is described in further detail below. Then, rApps 115, xApps 121, and dApps, 127 are instantiated from the app catalog 113 to the selected servers (e.g., on the servers running the non-RT RIC 105 for rApps 115, near-RT RIC 117 for xApps 121, and base stations 125, including central units (CU) and distributed units (DU), of the RAN cluster 123 for dApps 127) according to the optimal solution found in the previous step.

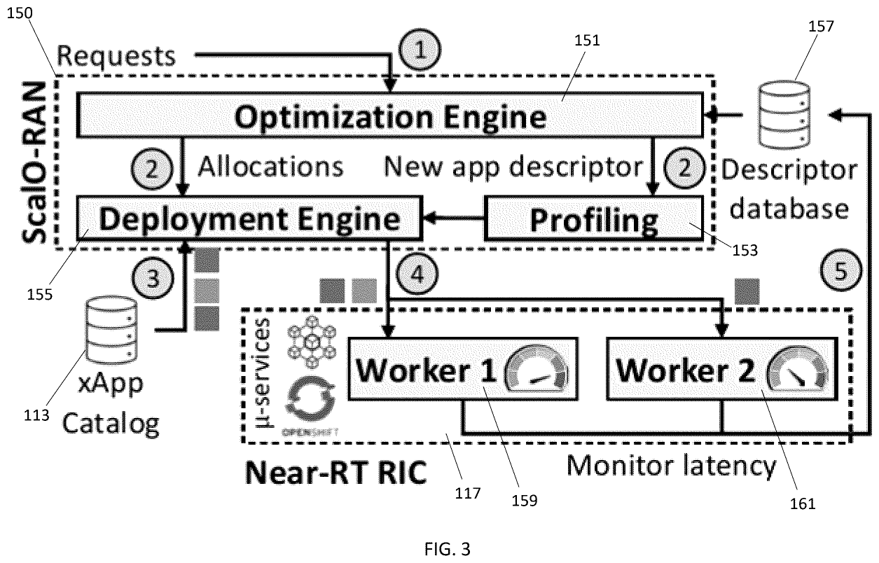

ScalO-RAN Prototype. ScalO-RAN was prototyped on a Red Hat OpenShift cluster with 8 Dell PowerEdge servers, including 3 control nodes and 5 worker nodes, two of which were reserved for ScalO-RAN workloads, running various Open RAN components, e.g., OSC RICs, Open5GS core network, and cellular base stations based on srsRAN and OpenAirInterface. FIG. 3 depicts the main building blocks of the prototype, which implements ScalO-RAN procedures in steps 1-5 through Continuous Integration (CI)/Continuous Deployment (CD) pipelines.

The prototype enables automated latency profiling for xApps 121 and embeds ScalO-RAN 150 as an rApp to optimize workloads deployment. Although ScalO-RAN 150 is generalized to be used in connection with any number of rApps 115, xApps 121, and dApps, 127, or combinations thereof, the prototype only focuses on xApps 121 to be instantiated on the near-RT RIC 117.

At step one, requests from the tenants to deploy xApps 121 are received by the SMO 103 and forwarded to the ScalO-RAN optimization engine 151. Each xApp 121 is assigned an app descriptor that specifies type, objective, input/output format of the embedded AI, among others. Available xApps 121 are stored in an App Catalog 113, but tenants can also request to deploy new xApps 121 not already included in the catalog 113.

Upon receiving a request, ScalO-RAN 150 determines whether or not the requested xApps 121 are present in the catalog 113. New xApps 121 (which lack an app descriptor in descriptor database 157) are first profiled 153 to benchmark their performance requirements at a first part of step 2. This is done by deploying the xApp on an idle worker 159, 161 through a ScalO-RAN deployment engine 155. xApp 121 deployment on the near-RT RIC 117 is automated using the dms_cli tool and Helm charts [41]. In case of xApps 121 having an app descriptor, the optimization engine 151 computes the optimal xApp allocation policy (e.g., using MATLAB and Gurobi for the prototype) to satisfy the received requests, and, at a second part of step 2, forwards the result to the deployment engine 155. At step 4, the deployment engine 155 retrieves the xApps 121 to instantiate from the xApp catalog 113, and allocates them on available worker nodes, (e.g., worker 1 (WN1) 159 and worker 2 (WN2) 161 as shown), based on the xApp latency constraints and on the expected run-time profile of the node. Finally, in step 5, the nodes of the cluster periodically report their runtime latency to ScalO-RAN 150.

### System Model

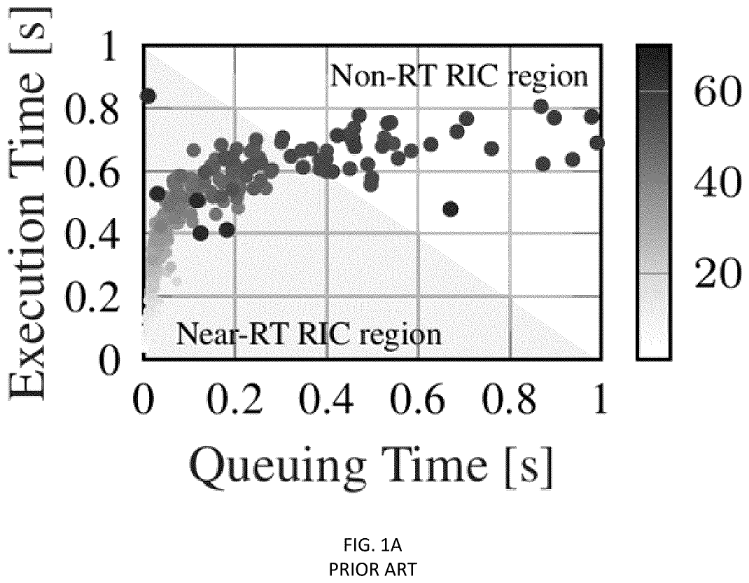

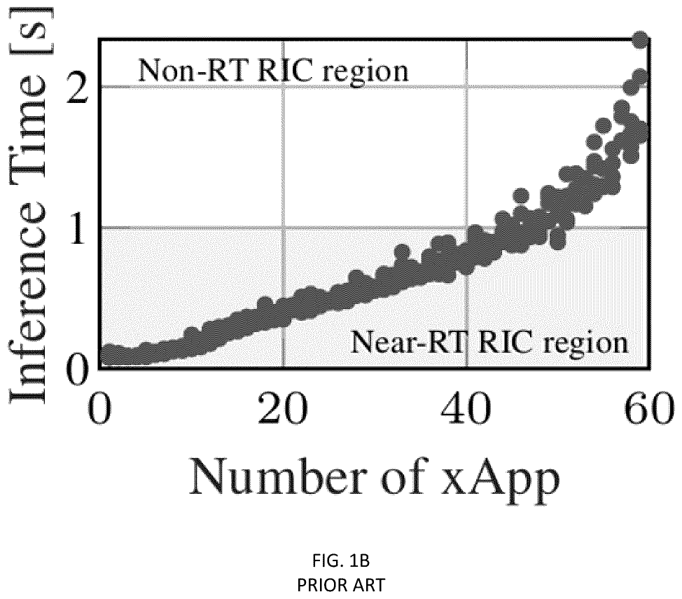

Infrastructure. The prototype ScalO-RAN 150 as provided herein is configured to be integrated within an Open RAN architecture as proposed by the O-RAN Alliance [2]. The cloud infrastructure is represented by the O-Cloud 101, which hosts RAN cluster 123 functions (e.g., base stations 125 including CUs, DUs, and Radio Units (RUs)), the non-RT RICs 105 and near-RT RICs 117, xApps 121, rApps 115, dApps 127, and the SMO framework 103. The O-Cloud 101 computing infrastructure has access to a set S of S=|S| servers. Although in principle servers in S could also host RAN functions and RICs (see FIG. 2), data-driven O-RAN applications consume significant resources (e.g., CPU, RAM), and they might congest the server where they execute, especially when their number is large (FIG. 1). For this reason, to ensure reliability and availability of networking functionalities, it is assumed that rApps 115, xApps 121, and dApps 127 execute on dedicated servers and let S denote their set only.

The servers co-located with a CU/DU 125 that can host dApps 127 can be identified with SCU/DU⊆S. ScalO-RAN 150 is designed to be in charge of instantiating applications and scaling computing resources for a single cluster. In the case of C clusters 123, C instances of ScalO-RAN 150 can be instantiated to serve each individual cluster 123.

O-RAN applications. The rApps, xApps, and dApps available to the tenants are stored in a catalog [symbol] on the non-RT RIC, with A=| [symbol] | AI-based applications. Without loss of generality, [symbol] = [symbol] ^{rApp}∪ [symbol] ^{xApp}∪ [symbol] ^{dApp}. Each application a∈ [symbol] is described via an app descriptor that specifies the delivered functionality (e.g., RAN slicing, traffic steering), the type of AI used (e.g., Deep Reinforcement Learning (DRL), Long Short Term Memory (LSTM), Convolutional Neural Network (CNN)), the type of application (e.g., xApp, rApp, dApp), the format and shape of input and output data (e.g., list of input KPIs and their shape, as well as type of action performed and its format), and its latency profile as detailed below.

Requests. Tenants sharing the O-RAN infrastructure might have conflicting interest, different business goals, and serve users with different Service Level Agreements (SLAs). To satisfy these requirements and meet their goals, tenants submit requests to deploy a selection of rApps, xApps, and dApps from the catalog [symbol] . Let [symbol] be the set of request submitted by all tenants. A request is modeled as a tuple r=(nᵣ, Lᵣ, δᵣ) where nᵣ= [symbol] , Lᵣ= [symbol] , δᵣ= [symbol] , and × indicates the Cartesian product. n_{r,a} represents the number of applications of type a∈ [symbol] that need to be instantiated to satisfy request r. Similarly, L_{r,a} represents the maximum inference time that the tenant tolerates executing applications of type a on any server. For example, a tenant could request n_{r,a′}=4 xApps to control RAN slicing policies of 4 DUs at a maximum tolerable inference time of L_{r,a′}=100 ms, as well as n_{r,a″}=1 rApp to control handover management with a desired inference time of L_{r,a″}=10. Note that controlling several RAN components with a single xApp or rApp is generally to be avoided, as it might result in congesting the micro-service and cause large inference times. For this reason, assume n_{r,a}≥1.

Tenants might submit requests that do not require any maximum inference time guarantee (e.g., L_{r,a}=+∞). However, by design the near-RT RIC should take decisions within 1 s, while dApps should take decisions within 10 ms. For this reason, a requirement

$${L}_{a}^{APP}$$

is introduced, which ensures that any application of type a produces an output within

$${L}_{a}^{APP}$$

For example, if application a∈ [symbol] ^{xApp},

$${L}_{a}^{APP} = 1 s , while {L}_{a}^{APP} = 10 ms$$

if a∈ [symbol] ^{dAPP}. Since O-RAN specifications do not provide any maximum inference time requirements for rApps, set

$${L}_{a}^{APP} = + ∞ for a ∈ {𝒜}^{rAPP} .$$

The parameter δ_{r,a,s}∈{0,1} is also introduced to identify the execution location of dApps. Specifically, δ_{r,a,s}=1 indicates that a dApp a∈ [symbol] ^{dAPP} needs to be executed at server s co-located with a CU/DU. Since s unequivocally identifies each server, s can be used to identify the target CU/DU required by the tenant. Set δ_{r,a,s}=0 for all a∈ [symbol] \ [symbol] ^{dAPP} and servers.

### A. Notation and Variables

The server activation profile can be introduced as x=(xₛ)_{s∈S}, where xₛ∈{0,1} indicates whether server s is actively hosting at least one AI-based O-RAN application (xₛ=1) or not (xₛ=0). To capture the allocation and instantiation of applications across the different servers, an allocation variable is introduced as y= [symbol] which indicates how many instances of app a for request r have been instantiated on server s. For each request r and application a, the variables y_{r,a,s} are defined over the (A·S−1)-simplex Δ_{r,a}= [symbol] ,

$${y}_{r , a , s} ∈ {ℤ}_{0}^{+} \vert {\sum }_{s ∈ S} {y}_{r , a , s} = {n}_{r , a} \} ,$$

with

$${ℤ}_{0}^{+}$$

being the set of positive integer numbers including 0. It follows that xₛ=1 if and only if [symbol] >1. An auxiliary indicator variable is introduced as w_{r,s}∈{0,1} for all r∈ [symbol] and s∈ [symbol] such that w_{r,s}=1 if and only if [symbol] >0, i.e., servers is hosting at least one instance of any application required by request r.

An indicator variable is also introduced as zᵣ∈{0,1} that, for each r∈ [symbol] , represents whether the allocation variable y satisfies the requirements of request r, both in terms of instances to be deployed, as well as latency (zᵣ=1), or not (zᵣ=0). An indicator variable π_{a,s}∈{0,1} is defined to determine the number Aₛ of different applications that have at least one instance running on server s. For all a∈ [symbol] and s∈S, π_{a,s}=1 if server s has at least one instance of application a, i.e., [symbol] >0, and π_{a,s}=0 otherwise. Aₛ is defined as follows:

$${A}_{s} = {\sum }_{a} {π}_{a , s} . \qquad ( 1 )$$

Finally, the following variables are defined: z= [symbol] , w= [symbol] , and π= [symbol] .

### Inference Time of O-RAN Applications

To properly satisfy inference constraints, first derive a latency model to regulate scaling and instantiation procedures and ensure that all applications can close the control loop within the desired temporal window. This section reports the results of a data collection campaign, where the OpenShift ScalO-RAN prototype described above was leveraged to gather data on how congestion and resource sharing affect the inference time of different AI architectures and algorithms.

### A. Profiling Inference Time

The inference time of AI-based O-RAN applications heavily depends on the complexity of the AI algorithms and architectures embedded in dApps, xApps, and rApps (e.g., width, depth, number of parameters and layers, need for convolutions). Indeed, shallower and simpler architectures such as feed-forward neural networks can produce an output faster than a deep and wide CNN requiring several chained convolution operations. Moreover, as shown in FIG. 1, the more applications coexist on the same hardware and share its resources, the more the inference time increases due to constrained computational resources. Thus, to properly quantify how resource sharing of coexisting applications affects their inference time, it is imperative to derive a model capable of capturing such dynamics.

AI for O-RAN systems can perform classification (e.g., anomaly detection), forecasting (e.g., KPI prediction), and control (e.g., resource allocation) [3]. Even if these tasks can be performed with multiple AI architectures (e.g., classification can use CNNs or Decision Trees, among others), in this analysis three well-established and diverse AI models were considered for each of the above tasks. Specifically, for classification, a CNN with 231,875 parameters and a fully connected output layer was used; for forecasting a LSTM with 49,987 parameters, bidirectional memory cells, and a fully connected output layer was used; and for control a DRL agent with more than 50,000 parameters was used.

The goal is to derive an inference time model to scale intelligent O-RAN applications. Thus, we only focus on evaluating their inference time, which is the same whether the AI has been trained or not, as the number of operations (e.g., multiplications, convolutions, additions) to perform is the same.

In this regard, a single worker node of the OpenShift cluster was considered and one xApp instance was deployed at a time. To collect the data at scale, an E2 traffic generator was developed using the opensource O-RAN dataset from [42]. The generator emulates E2 traffic by constantly extracting at random KPIs from the dataset, with a format that matches the input expected by the xApp AI models (e.g., which KPI to extract and the shape of the input), as specified in the app descriptor of each xApp.

Whenever a new instance of xApp a was added on server s, the traffic generator was used to produce input data for the new instance and measure three types of latency: (i) queuing time

$${t}_{a , s}^{q u e u e} ,$$

which measures how long it takes for the xApp to ingest the input once it has been received at the E2 termination of the near-RT RIC; (ii) execution time

$${t}_{a , s}^{e x e c} ,$$

measuring the time to produce an output once an xApp receives an input; and (iii) inference time to

$${t}_{a , s}^{inf} = {t}_{a , s}^{q u e u e} + {t}_{a , s}^{e x e c} .$$

CPU and RAM utilization of the server were also tracked.

One could also consider both the time needed to forward the KPIs and the control action between the RAN and the RICs. However, since all servers are co-located in the same cluster, these parameters are constant. Moreover, data over high-speed optical fiber links has low and predictable latency (few hundreds of milliseconds, including switching), which is negligible if compared to the timescale of the near-RT RIC (i.e., below 1 s) and non-RT RIC (i.e., at or above 1 s). For these reasons, these terms were not included in the model. Under these assumptions, the inference time when y instances of application a∈ [symbol] are executing on server s was defined as follows:

$${t}_{a , s}^{inf} ( y ) = {t}_{a , s}^{e x e c} ( y ) + {t}_{a , s}^{q u e u e} ( y ) . \qquad ( 2 )$$

### B. Deriving a Latency Model

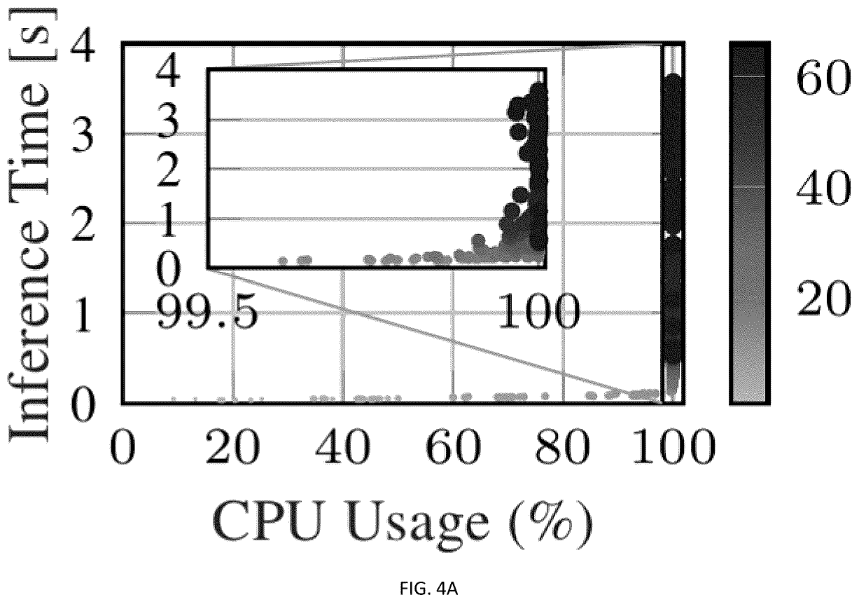

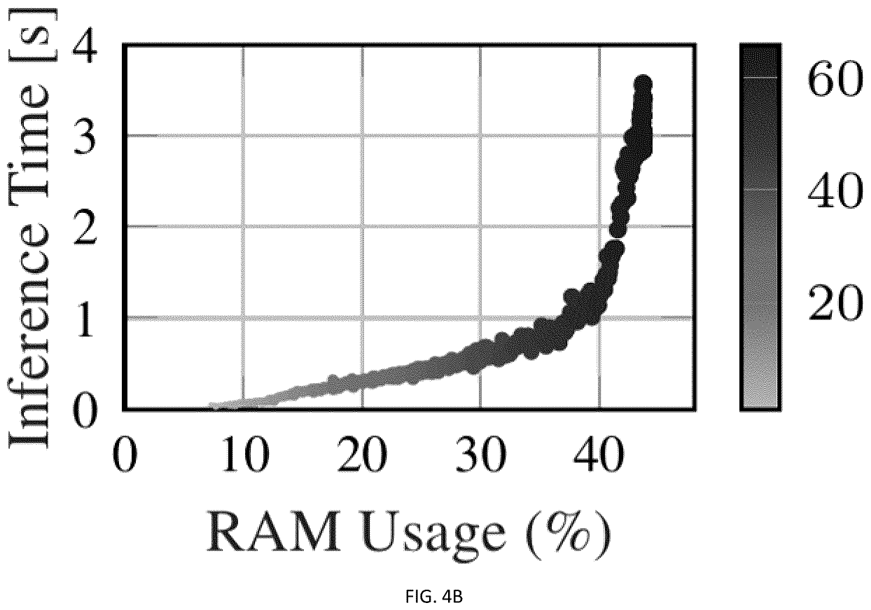

FIG. 4 shows how the inference time varies as a function of the CPU utilization and number of xApps (uniformly distributed between CNN, LSTM and DRL). It was noticed that 20 xApps already consume 100% of the CPU: this saturation prevents accurate modeling of the execution time from the CPU utilization alone. RAM usage brings more insights, but predicting inference time from RAM occupation is hard as two models might use the same RAM but execute at different speeds. To overcome the above limitation, focus was instead on measuring both

$${t}_{a , s}^{e x e c} and {t}_{a , s}^{q u e u e}$$

and deriving an inference time model from these paameters.

To better understand how execution and queuing time affect

$${t}_{a , s}^{inf} ( y ) ,$$

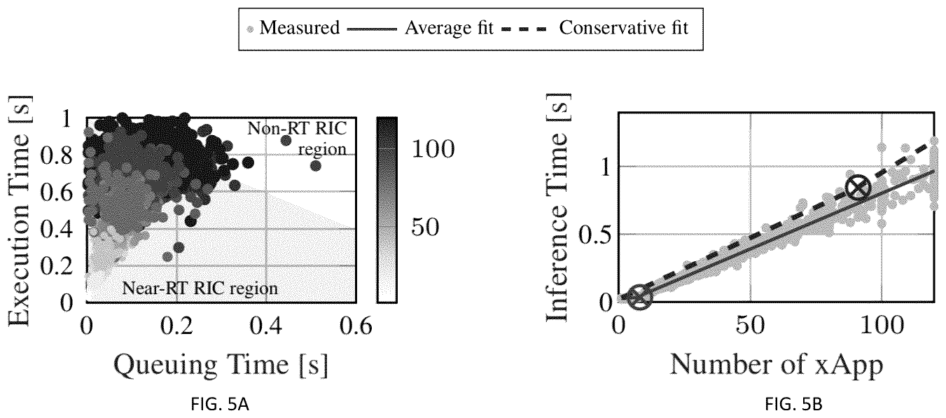

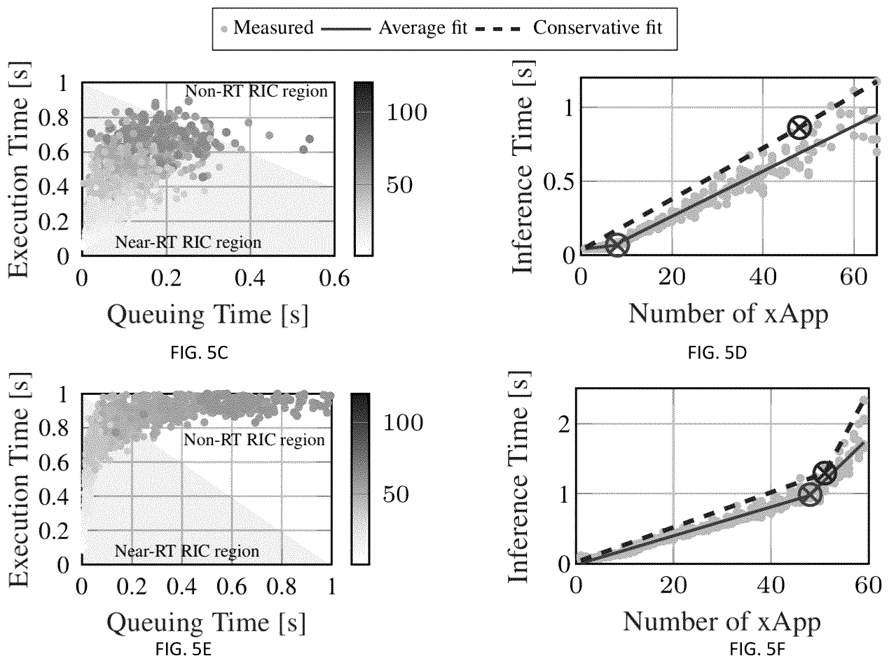

### in FIGS. 5A, 5C, and 5E,

$${t}^{e x e c} ( y ) and {t}^{q u e u e} ( y )$$

are shown for the different xApp types when y instances of the same xApp execute on the server, while the respective

$${t}_{a , s}^{inf} ( y )$$

is shown in FIGS. 5B, 5D, and 5F. On the other hand, in prior art FIGS. 1A and 1B, results were obtained by instantiating y instances of the three xApps at the same time. Prior art FIGS. 1A-1B and FIGS. 5A, 5C, and 5E also show the regions identifying the near-RT RIC's and non-RT RIC's operational domains. In general, it is noticed that the execution time

$${t}_{a , s}^{e x e c} ( y )$$

strongly affects inference time when y is small, while

$${t}_{a , s}^{q u e u e} ( y )$$

becomes relevant when y grows due to congestion. These results suggest that inference time can be modeled using an increasing function with two distinct regions: a region where inference time grows at a moderate rate with the number of applications running on the server, and a congestion region with a steep increasing trend.

Although one can compute such functions in several ways (e.g., linear regression, neural networks), the present technology aims at estimating latency with a model that is accurate, simple to integrate into an optimization problem, and reduces the underestimation risks to avoid deploying AI that would violate maximum latency requirements. For this reason, inference time was modeled via piecewise linear regression. This has several advantages: i) it is general, ii) it can be used to accurately approximate non-linear functions, and iii) it can be used to remove non-linearities in optimization problems, thus resulting in lower complexity [43]. In general, one could compute the minimum amount of segments necessary for the approximation by using the piecewise linearization methods in [43]. However, the data analysis described herein suggests that inference time behaves as an “elbow” function. Thus a 2-segment piecewise linear regression [44] was used, which describes a function ƒ(y) as ƒ(y)=λ₁·y+b₁ if y≤y₀, and ƒ(y)=λ₂·y+b₂ if y>y₀, where y₀ is the break point, λᵢ is the slope and bᵢ is the intercept of the i-th segment.

FIGS. 5B, 5D, and 5F also show that

$${t}_{a , s}^{inf} ( y )$$

can be approximated using the following 2-segment piecewise linear function:

$${\tilde{t}}_{a , s}^{inf} ( y ) = \{ \begin{matrix}{λ}_{a , s}^{I} \cdot y + {b}_{a , s}^{I} & if y \leq {\tilde{y}}_{a , s} \\ {λ}_{a , s}^{II} \cdot y + {b}_{a , s}^{II} & otherwise ,\end{matrix} \qquad ( 3 )$$

where \tilde{y}_{a,s} is the break point, and

$${λ}_{a , s}^{i} and {b}_{a , s}^{i}$$

are the slope and intercept of the i-th segment, with i∈{I, II}. The values of \tilde{y}_{a,s},

$${λ}_{a , s}^{I} m and {λ}_{a , s}^{II}$$

for the applications considered herein were extracted via piecewise linear regression from the data collected on the prototype and are reported in Table I.

TABLE I
Piecewise Regression Parameters.

| | Conservative fit | | | | | Average fit | | | | |
|---|---|---|---|---|---|---|---|---|---|---|
| | λ^{I} | b^{I} | λ^{II} | b^{II} | \tilde{y} | λ^{I} | b^{I} | λ^{II} | b^{II} | \tilde{y} |
| CNN | 9.057 | 18.94 | 11.73 | −218.9 | 92 | 1.535 | 20.97 | 8.237 | −22.3 | 9 |
| LSTM | 17.27 | 32.73 | 18.21 | −10.68 | 49 | 3.498 | 38.99 | 15.26 | −43.47 | 9 |
| DRL | 24.88 | 25.12 | 130 | −5336 | 51 | 20.56 | −10.54 | 67.45 | −2250 | 48 |

FIGS. 5B, 5D, and 5F illustrate the outcome of piecewise linearization of the inference time function for the ML-based control xApps for two cases: an average fit where the average behavior can be approximated; and a conservative fit where upper bounds in the data can be accounted for via piecewise linear bounding [45]. It is noted that both linearizations offer a good approximation that captures the elbow-shaped behavior of the distribution. The average fit might result in underestimations and violation of latency requirements, as it only captures the expected behavior. To mitigate this phenomenon, the conservative fit can be used, which also accounts for the variance of measurements, especially when the number of deployed applications is high.

The application-specific inference model is now extended to a more general case where the same server hosts several instances of different applications. Note that while the measurement campaign profiled AI models packaged as xApps, the same latency model would hold when they are packaged as dApps or rApps. Let y_{r,a,s} be the number of instances of applications of type a from any request r executing on server s. The inference time of all instances executing on server s can be expressed as

$${l}_{s} ( y , π ) = \frac{1}{{A}_{s}} {\sum }_{a ∈ 𝒜} {\tilde{t}}_{a , s}^{inf} ( {Y}_{s} ) {π}_{a , s} , \qquad ( 4 )$$

where Yₛ= [symbol] is the total number of application instances hosted on s∈ [symbol] ,

$${\tilde{t}}_{a , s}^{inf} ( \cdot )$$

is defined in Eq. (3), and Aₛ from Eq. (1) is a function of π. The expression in Eq. (4) models the expected value of the inference time when multiple instances of different applications are executed on the same server.

### ScalO-RAN Optimization Engine

In this section, the instantiation and scaling problem for intelligent O-RAN applications is introduced. Then, design of an objective function that can capture diverse needs such as reducing energy and maximizing profit is described.

### A. Formulating the Problem

With the notation and variables defined in Sec. IV-A, the Instantiation and Scaling Problem (ISP) can be formulated as:

$${{max}_{x , y , z ,}}_{w , π} U ( x , y , z , w , π ) ( ISP )$$

$$s . t . : {\sum }_{s ∈ 𝒮} {y}_{r , a , s} \geq {n}_{r , a} - {M}_{1} ( 1 - {z}_{r} ) , ∀ ( r , a ) ∈ ℛ \times 𝒜 \qquad ( 5 )$$

$${\sum }_{s ∈ 𝒮} {y}_{r , a , s} \leq {n}_{r , a} + {M}_{1} ( 1 - {z}_{r} ) , ∀ ( r , a ) ∈ ℛ \times 𝒜 \qquad ( 6 )$$

$${y}_{r , a , s} \leq {n}_{r , a} \cdot {x}_{s} , ∀ ( r , a , s ) ∈ ℛ \times 𝒜 \times 𝒮 \qquad ( 7 )$$

$${l}_{s} ( y , π ) {w}_{r , s} \leq {L}_{r , a}^{M AX} , ∀ ( r , a , s ) ∈ ℛ \times 𝒜 \times 𝒮 \qquad ( 8 )$$

$${π}_{a , s} \leq {x}_{s} , ∀ ( a , s ) ∈ 𝒜 \times 𝒮 \qquad ( 9 )$$

$${\sum }_{r ∈ ℛ} {y}_{r , a , s} \geq 1 - {M}_{2} ( 1 - {π}_{s , a} ) , ∀ ( a , s ) ∈ 𝒜 \times 𝒮 \qquad ( 10 )$$

$${\sum }_{r ∈ ℛ} {y}_{r , a , s} \leq {M}_{2} \cdot {π}_{s , a} , ∀ ( a , s ) ∈ 𝒜 \times 𝒮 \qquad ( 11 )$$

$${\sum }_{a ∈ 𝒜} {y}_{r , a , s} \geq 1 - {M}_{3} ( 1 - {w}_{r , s} ) , ∀ ( r , s ) ∈ ℛ \times 𝒮 \qquad ( 12 )$$

$${\sum }_{a ∈ 𝒜} {y}_{r , a , s} \leq {M}_{3} \cdot {w}_{r , s} , ∀ ( r , s ) ∈ ℛ \times 𝒮 \qquad ( 13 )$$

$${w}_{r , s} \geq - {M}_{4} ( 1 - {x}_{s} ) , ∀ ( r , s ) ∈ ℛ \times 𝒮 \qquad ( 14 )$$

$${w}_{r , s} \leq {M}_{4} \cdot {x}_{s} , ∀ ( r , s ) ∈ ℛ \times 𝒮 \qquad ( 15 )$$

$${w}_{r , s} \leq {z}_{r} , ∀ ( r , s ) ∈ ℛ \times 𝒮 \qquad ( 16 )$$

$${y}_{r , a , s} \leq {δ}_{r , a , s} , ∀ ( r , s ) ∈ ℛ \times 𝒮 \qquad ( 17 )$$

where U(⋅) is the objective function (discussed below),

$${L}_{r , a}^{M A X} = min \{ {L}_{r , a} , {L}_{a}^{A P P} \} ,$$

lₛ(y, π) is defined in Eq. (4), and M₁=M₂= [symbol] n_{r,a}+1, M₃= [symbol] {n_{r,a}}+1, M₄=1 are coefficients used to formulate conditional constraints (e.g., applications can be instantiated on a server if and only if the server is active) using the big-M notation. Specifically, Eqs. (5)-(6) ensure that a sufficient condition for a request r to be considered satisfied is that all required applications must be allocated and satisfy nᵣ. Eq. (7) ensures that instances of application a requested by r can be instantiated only on active servers and the number of instances cannot exceed the demand. Eq. (8) ensures that all latency requirements (from tenants or from O-RAN specifications) are satisfied. Eq. (9) ensures that application instances can run on active servers only, while Eqs. (10)-(11) ensure that the indicator variable π_{a,s} is activated if and only if there is at least one instance of application of type a running on server s. Similarly, Eqs. (12)-(15) ensure that w_{r,s}=1 if and only if there is at least one instance of any application requested by r running on an active server s. Finally, Eq. (16) ensures that w_{r,s}=1 only if the request can be satisfied completely (i.e., if zᵣ=1), and Eq. (17) guarantees that dApps are instantiated only at CUs and DUs selected by the tenants. From Eqs. (3) and (1), Eq. (8) is non-linear but can be reformulated via the following big-M formulation

$${\sum }_{a ∈ 𝒜} {\tilde{t}}_{a , s}^{inf} ( {Y}_{s} ) {π}_{a , s} \leq {L}_{r , a}^{M A X} + {M}_{5} ( 1 - {w}_{r , s} ) , \qquad ( 18 )$$

where M₅ is a large real-valued positive number, and \tilde{t}_{a,s}^{inf}(Yₛ) is a piecewise function from Eq. (3) as follows:

$${\tilde{t}}_{a , s}^{inf} ( {Y}_{s} ) = {v}_{a , s} ( {λ}_{a , s}^{I} \cdot {\sum }_{{r}^{′} ∈ ℛ} {y}_{{r}^{′} , a , s} + {b}_{a , s}^{I} ) + ( 1 - {v}_{a , s} ) ( {λ}_{a , s}^{III} \cdot {\tilde{y}}_{a , s} + {λ}_{a , s}^{II} {\sum }_{{r}^{′} ∈ ℛ} {y}_{{r}^{′} , a , s} ) \qquad ( 19 )$$

where v_{a,s}∈{0,1} is an auxiliary variable that activates the first segment of the piecewise function if [symbol] <\tilde{y}_{a,s}, or the second segment otherwise. Note that Eq. (19) is quadratic due to the products between v_{a,s} and y_{r′,a,s}. However, these products can be linearized by adding auxiliary variables τ_{r′,a,s}∈{0,1} such that τ_{r′,a,s}≤v_{a,s} and τ_{r′,a,s}≤y_{r′,a,s}. By combining Eq. (19) and its linearization into Eq. (18), a quadratic constraint is obtained due to the product with π_{a,s}.

### B. Objective Function Design

Energy minimization is one of the major drivers of Open RAN, which can scale cloud compute on-the-fly to only activate the resources necessary for service delivery. To meet these expectations, the total energy cost of activating servers and instantiating O-RAN applications is considered by:

$${E}_{s} ( {x}_{s} , {y}_{s} ) = {x}_{s} \cdot {E}_{s}^{b a s e} + {\sum }_{a ∈ 𝒜} {\sum }_{r ∈ ℛ} {y}_{r , a , s} {e}_{a , s} , \qquad ( 20 )$$

yₛ= [symbol] ,

$${E}_{ s}^{base}$$

represents the fixed amount of energy consumed by server s when turned on (i.e., with at least one application deployed), and e_{a,s} models the energy for an application of type a. Eq. (20) is based on experimental evidence showing that energy consumption scales linearly with the server load [46], represented here by the number of applications on the server (last term in Eq. (20)). Moreover, Eₛ(xₛ, yₛ)=0 when xₛ=0, and Eq. (7) forces all y_{r,a,s}=0 to ensure applications selection prioritizes already active servers.

In general, infrastructure owners aim at maximizing profit by minimizing the energy consumed to deliver the most valuable services. Such an energy-aware profit maximization problem is formulated with the following objective function:

$$U ( x , y , z ) = {\sum }_{r ∈ ℛ} {ρ}_{r} {z}_{r} - σ {\sum }_{s ∈ 𝒮} {E}_{s} ( {x}_{s} , {y}_{s} ) , \qquad ( 21 )$$

where ρᵣ represents the monetary payment that the tenant is willing to pay to have their O-RAN applications deployed on the infrastructure, σ is the cost of energy expressed in monetary units per Joule, and Eₛ(⋅) is defined in Eq. (20).

### C. Computational Complexity

Theorem 1. Problem (ISP) is NP-hard.

Proof: The proof is based on reducing the problem to the quadratically-constrained knapsack problem (QCKP), which is known to be NP-Hard [47]. Consider the case S=1, [symbol] =1 for all r∈ [symbol] (i.e., one appliCation per request). Assume δ_{r,a,s}=1 for all (r, a, s)∈ [symbol] × [symbol] × [symbol] , and

$${L}_{r , a}^{M A X} = L$$

for all (r, a)∈ [symbol] × [symbol] , with L a small enough constant that prevents the use of the only server to accommodate all requests. Since each request is associated to one application only, let λᵣ=λₐ(1), where a is the only type of application requested. Recall that the latency function lₛ(⋅) in Eq. (8) is an increasing function in the number of requests hosted in each server, and each allocated request contributes with a factor λᵣ to the total inference time. Problem (ISP) corresponds to an instance of the QCKP with one knapsack (the server) with capacity L (the inference time) and R objects (the requests) of value ρᵣ and size λᵣ, with a total value (monetary reward minus the cost) maximization goal. This problem is NP-hard [47] and a polynomial-time reduction of the QCKP to an instance of Problem (ISP) has been built. Thus, Problem (ISP) is NP-hard by reduction unless P=NP.

Despite its NP-hardness, Problem (ISP) can be solved optimally via well-established optimization frameworks such as branch-and-bound [47]. As described below, it has been shown that an optimal solution only requires a few seconds even for large instances of the problem with thousands of O-RAN applications, which is satisfactory and well within the non-real-time requirement of lifecycle management of O-RAN applications [2], and an approximation algorithm that offers lower complexity with slightly lower performance in terms of optimality is also considered.

### Performance Evaluation

ScalO-RAN was numerically evaluated in MATLAB where Problem (ISP) was solved in Gurobi on a server with an Intel Core i9-9980HK CPU with 16 cores and 64 GB of RAM. For all simulations, plotted results were averaged over 50 experiments.

Consider the 3 types of xApps in Table I and a conservative fit for Eq. (8). The idle energy is

$${E}_{s}^{b a s e} = 360 J$$

(Dell PowerEdge R750) and e_{a,s}={8.77,16,22} J for CNN, LSTM and DRL models by combining the inference/s time from FIGS. 5A-5F and the energy consumption per inference in [48]. The energy cost is σ=0.165$/kWh (current average in the U.S.).

Consider three possible inference time profiles such that L_{r,a}∈{0.2,1,10}s and consider the case where

$${L}_{r , a}^{M A X} = {L}_{r , a}$$

for all (r,a)∈ [symbol] × [symbol] . Do not distinguish between dApps, xApps, and rApps, prioritizing the desired inference time required by each tenant. Refer to the above inference time profiles as Real-time (RT), near-RT and non-RT, respectively. For each request r, set n_{r,a′}=n_{r,a″} for any (a′, a″) and randomly select one inference time demand from the set defined above with probability 10%, 60%, 30% for RT, near-RT, and non-RT, respectively. In the following, results are presented as a function of the total number of instances requested by all tenants which is defined as I= [symbol] . Due to space limitations, consider homogeneous requests with same monetary value ρᵣ=2$ and same total number [symbol] of application instances requested. The number of requests is R=5 and we vary [symbol] to emulate very small or very large numbers of AI models for the control of a certain O-RAN deployment.

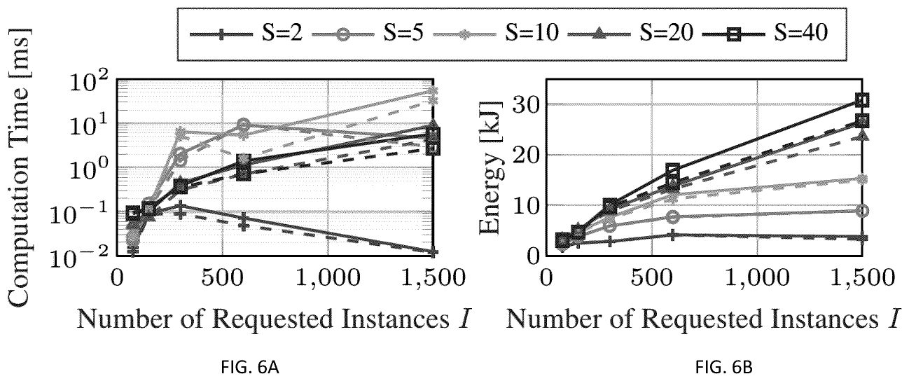

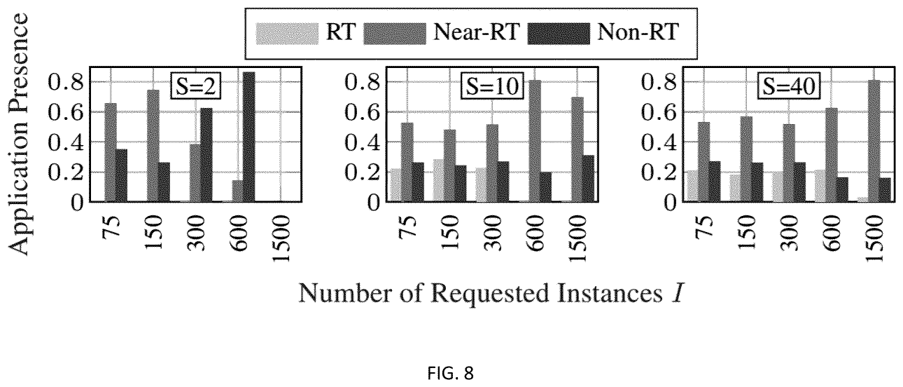

First, analyze the complexity of solving Problem (ISP) optimally (solid lines). FIG. 6A shows the computation time as a function of I for different number of servers S. Intuitively, the complexity grows with the number of AI models (I) to deploy up to a threshold I*, where the trend reverses. As described in connection with FIG. 8 below, this happens because for large I the optimization engine neglects requests with RT and near-RT inference profiles, prioritizing non-RT requests which can be satisfied in larger numbers. Indeed, the cost for accommodating RT and near-RT requests is too high (they force a limit on the inference time for the entire server) as it prevents the admission of non-RT requests. Thus the algorithm discards their branches, converging faster to an optimal solution. Comparison was also made against an approximation approach (dashed lines) where early stopping was performed on the branch-and-bound procedure when all reduced costs of the underlying dual problem were less than 0.01. As expected, early stopping produces sub-optimal solutions in less time, with a 2.16×gain when S=40.

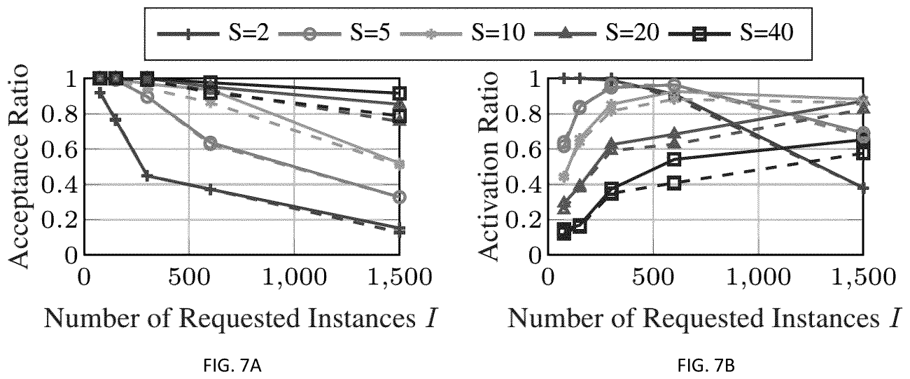

FIG. 6B shows that the total energy consumption always increases with I, with a plateau when no more requests can be admitted. Early stopping computes solutions that consume less energy than the optimal. This is a consequence of its lower acceptance ratio (i.e., the ratio between the number of AI models actually instantiated and I, as shown in FIG. 7A) and lower activation ratio (i.e., the percentage of servers that host at least one application, as shown in FIG. 7B). The optimal solution satisfies more than 90% of requests with 65% servers activated when S=40.

FIG. 7A shows that the acceptance ratio decreases with I and increases with larger number of available servers S. Differently, the activation ratio trend (FIG. 7B) is similar to that of the complexity (FIG. 6A). Indeed, when the number of servers S in the cluster is small, the activation ratio decreases with I, as it becomes impossible to allocate even a single RT or near-RT without violating Eq. (8) with high probability.

FIG. 8 shows the application presence probability, i.e., the probability that requests with diverse inference time profiles are admitted by ScalO-RAN. When S=2, RT requests are completely neglected, as they limit the number of admissible AI models. This is at least partially because constraint Eq. (8) forces a server to satisfy the latency requirement of the most demanding application being hosted in the server. Indeed, it can be seen that with more servers it is possible to admit more RT and near-RT requests. These results clearly show that scaling AI solutions in O-RAN systems is not a resource-constrained problem, but a time-constrained one in that requirements on the inference time strongly affect how many dApps, xApps and rApps can coexist on the same server.

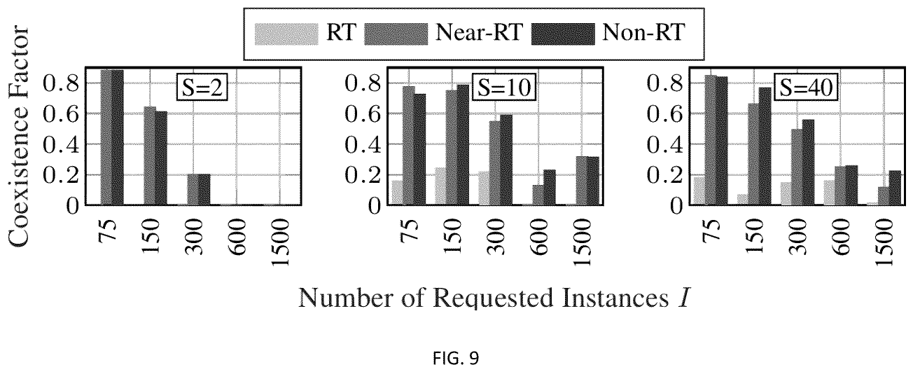

FIG. 9 shows the probability that requests with diverse inference time profiles coexist on the same server. RT requests are less likely to share the same server with other profiles. For I≤300, both near-RT and non-RT requests can coexist with a probability higher than 0.5, which however drops to approximately 0.2 when I is large.

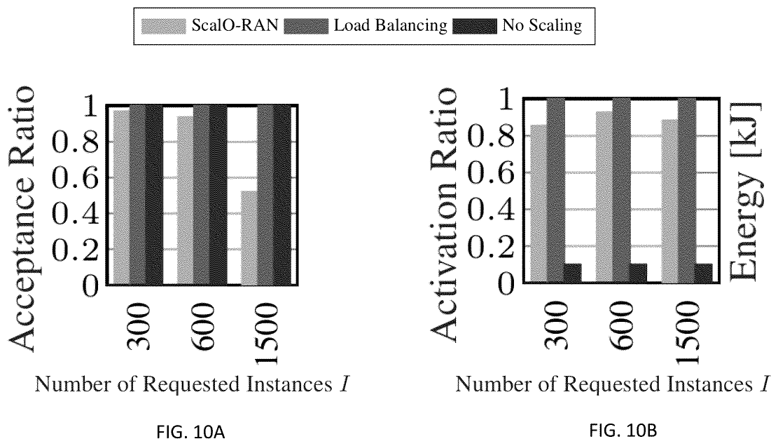

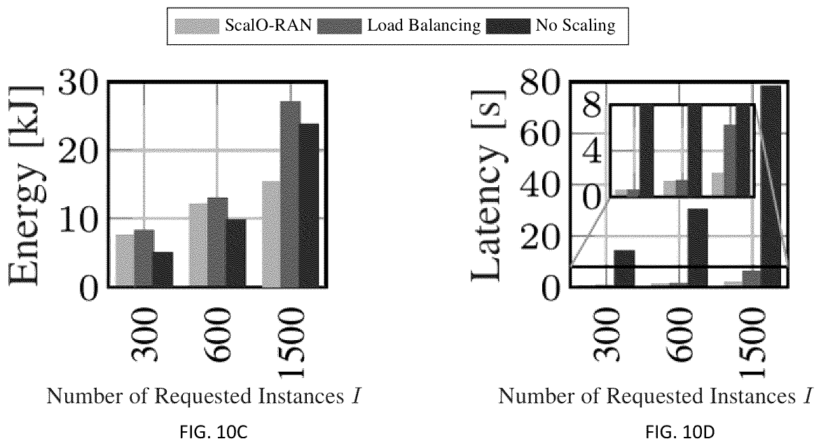

Finally, FIGS. 10A-10D compare ScalO-RAN against two other approaches for S=10: i) resource-based load balancing (native in OpenShift and frequently considered in the literature [14-16]) and ii) no scaling. Load balancing distributes requests among servers based on congestion levels, while with no scaling all requests are instantiated on a single server. Load balancing and no scaling always admit all requests, while ScalO-RAN accepts ˜98% of requests when I=300 and 52% when I=1500. Moreover, the no scaling approach activates one server only, the load balancing approach activates all servers, and ScalO-RAN activates on average 90% of servers. The lower ScalO-RAN acceptance and activation ratios are not a drawback, but a consequence of the energy-aware profit maximization objective coupled with the maximum inference time requirement. Together, these force ScalO-RAN to accept and distribute only those requests that guarantee timely inference time as requested by tenants.

Indeed, we see that the no scaling approach is not suitable for O-RAN applications due to the extremely high inference time (see FIG. 10D). If compared to load balancing, ScalO-RAN provides a lower energy consumption and a lower inference time, which also satisfies timing requirements from tenants. Overall, ScalO-RAN performs better than widely used load balancing approaches by reducing energy while guaranteeing a timely inference.

### Experimental Results

The prototype described above was used to experimentally evaluate ScalO-RAN and compare it against load balancing policies of OpenShift. Using the performance evaluation setup described above, with the three AI-based xApps in FIG. 5, the average fit in Table I and I=123 xApp instances to be deployed. The prototype embeds two Dell PowerEdge R340 worker nodes (e.g., WN1 159, WN2 161 of FIG. 3) for a near-RT RIC, thus R=3 tenants was considered with one request each (r₁, r₂ and r₃) to mimic a small O-RAN deployment. near-RT inference time profiles ([350,1000] ms) were considered, and only r₁ demands the maximum inference time of 350 ms. The monetary value is ρᵣ_{₁}=30ρᵣ_{₂}=30ρᵣ_{₃}.

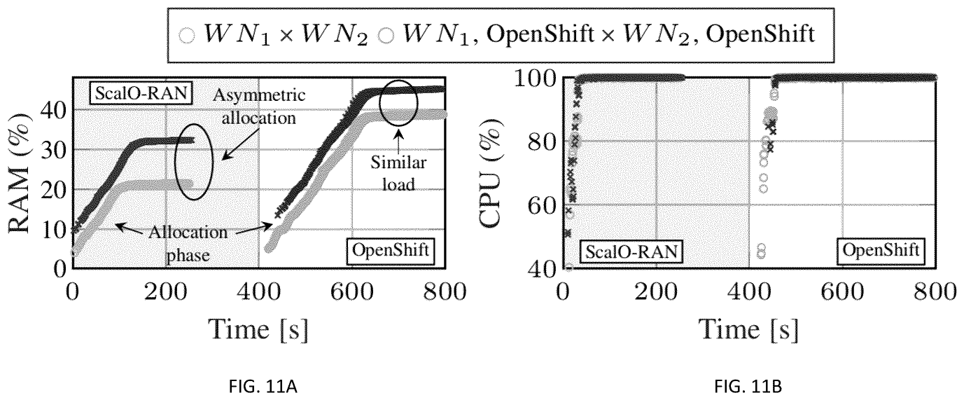

FIGS. 11A-11B show the CPU and RAM utilization over time for both ScalO-RAN and OpenShift for a single 4-minute experiment. Here, ScalO-RAN admits only requests r₁ and r₂ (demanding 350 ms and 1000 ms, respectively) instantiating 82 xApps, while OpenShift admits all requests and all 123 xApps. As shown, OpenShift allocates all xApps evenly across WN₁ and WN₂ due to load balancing. Instead, ScalO-RAN allocates instances in a more asymmetric way. Specifically, 85% of xApps on WN₁ are from r₁, and the remaining 15% is from r₂. In addition, 100% of xApps on WN₂ are from r₂. This allocation, especially the allocation on WN₁, ensures that all xApps satisfy the 350 ms inference constraint on WN₁ as required by r₁. CPU usage is almost 100% except for the initial deployment phase. The allocation phase is voluntarily slow, as one xApp was allocated at a time to facilitate the collection of reliable data.

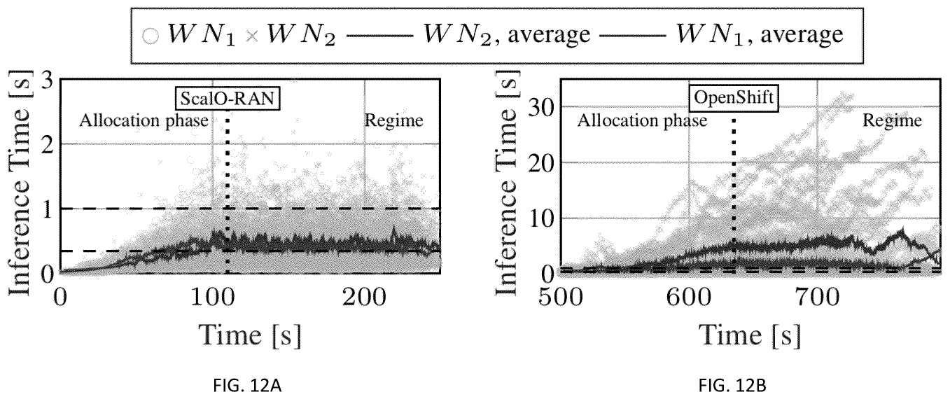

FIGS. 12A-12B report the inference time over time for ScalO-RAN and OpenShift. It is shown that OpenShift cannot satisfy even the 1000 ms requirement, as it allocates all xApps without considering their timing requirements. This results in inference time violations that affect the proper functioning of the RAN. Instead, ScalO-RAN not only admits requests whose demands can be accommodated, but distributes xApps to ensure that WN₁ (which hosts all xApps of r₁ and 15% of xApps of r₂) delivers the 350 ms requirements on average, while WN₂ can guarantee the 1000 ms requirement from r₂.

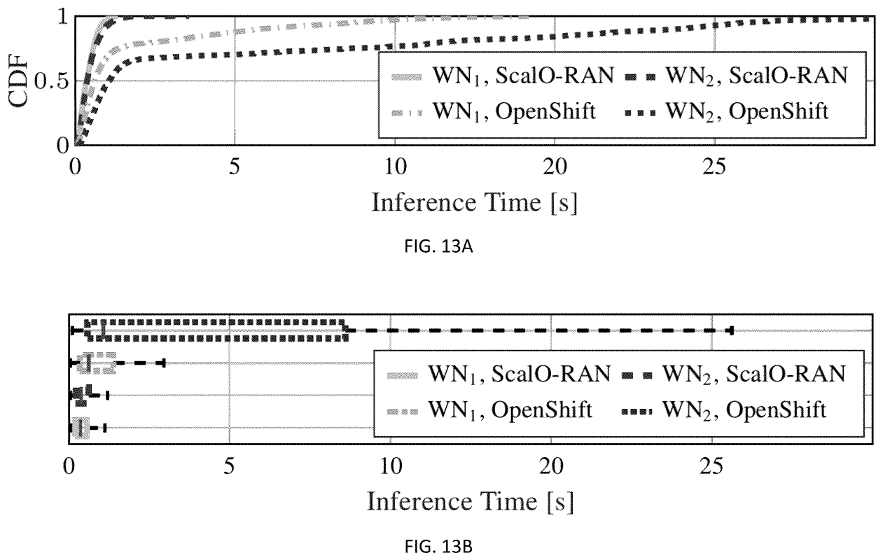

Finally, in FIG. 13A, a Cumulative Distribution Function (CDF) for the different worker nodes and approaches is shown and, in FIG. 13B, boxplots showing median values are shown. As shown, OpenShift cannot guarantee any inference time demand, while ScalO-RAN ensures that the expected inference time follows tenant requirements.

Thus, provided herein is ScalO-RAN, an O-RAN energy-aware scaling system to enforce inference time constraints on intelligent applications. A latency model based on a measurement campaign on an OpenShift cluster, a mathematical optimization model, and an O-RAN compliant prototype were provided. ScalO-RAN was compared with Open-Shift's scaling mechanism, showing that ScalO-RAN is able to deploy O-RAN applications complying with specific latency constraints required by network operators. In particular, results demonstrate that scaling AI solutions in O-RAN systems is not resource constrained only, but time-constrained in that requirements on the inference time strongly affect how many dApps, xApps and rApps can coexist on the same server.

The present technology includes the at least the following novel features:

1. It optimizes the deployment of O-RAN applications (e.g., xApp, rApp, and dApp) based on AI inference time constraints while minimizing energy consumption and resource utilization.

2. It scales up/down compute systems based on O-RAN applications to deploy requests from network operator.

3. It provides benchmark energy and inference time profiles of applications to then deploy them on infrastructure according to energy budget to perform inference/control of the Open RAN nodes (e.g., of the base stations).

The present technology includes the following advantages and improvements over previous technology:

1. It improves energy efficiency of Open RAN systems.

2. It performs cloud scaling of O-RAN applications to ensure that AI can take decisions within the desired temporal window to timely control and monitor the network.

3. It profiles energy consumption and inference time of applications, and optimizes their deployment based on the energy budget.

4. It offers financial advantages for telecom operators. It is expected that the rollout of Open RAN architectures will be gradual, and for several years Open RAN technologies will coexist with legacy RAN deployments. This coexistence forces telco operators and infrastructure owners to maintain old management and control solutions (e.g., Self-organizing networks (SON) platforms) for the legacy RAN portion of the network, which results in high licensing fees and expenses that will be necessary until the entirety of the legacy RAN has been discontinued. The present technology allows operators to first profile the energy consumed by O-RAN application, and then deploy them based on this profiling, the available infrastructure, and the energy budget of the operator. Overall, this allows operators to save energy in the deployment of O-RAN applications that perform inference/control of the Open RAN components (e.g., the base stations).

Uses of the present technology can be used by telco operators (both green and brown), as well as for public and private 5G and beyond applications, such as smart ports, industry 4.0, manufacturing, and many other applications.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

### REFERENCES

[1] K. Benzekki, A. E. Fergougui, and A. E. Elalaoui, “Software-defined networking (SDN): A Survey,” Security and Communication Networks, vol. 9, no. 18, pp. 5803-5833, December 2016.
[2] M. Polese, L. Bonati, S. D'Oro, S. Basagni, and T. Melodia, “Understanding O-RAN: Architecture, Interfaces, Algorithms, Security, and Research Challenges,” IEEE Communications Surveys & Tutorials, 2023.
[3] B. Brik, K. Boutiba, and A. Ksentini, “Deep Learning for B5G Open Radio Access Network: Evolution, Survey, Case Studies, and Challenges,” IEEE Open Journal of the Communications Society, vol. 3, 2022.
[4] S. D'Oro, M. Polese, L. Bonati, H. Cheng, and T. Melodia, “dApps: Distributed Applications for Real-Time Inference and Control in O-RAN,” IEEE Communications Magazine, vol. 60, no. 11, 2022.
[5] R. Schmidt and N. Nikaein, “RAN Engine: Service-Oriented RAN Through Containerized Micro-Services,” IEEE Transactions on Network and Service Management, vol. 18, no. 1, pp. 469-481, March 2021.
[6] S. Niknam, A. Roy, H. S. Dhillon, S. Singh, R. Banerji, J. H. Reed, N. Saxena, and S. Yoon, “Intelligent O-RAN for Beyond 5G and 6G Wireless Networks,” in IEEE Globecom Workshops, December 2022.
[7] L. Bonati, S. D'Oro, M. Polese, S. Basagni, and T. Melodia, “Intelligence and Learning in O-RAN for Data-driven NextG Cellular Networks,” IEEE Communications Magazine, vol. 59, no. 10, pp. 21-27, October 2021.
[8] B. Ojaghi, F. Adelantado, and C. Verikoukis, “On the Benefits of vDU Standardization in Softwarized NG-RAN: Enabling Technologies, Challenges, and Opportunities,” IEEE Communications Magazine, vol. 61, no. 4, pp. 92-98, April 2023.
[9] G. Garcia-Aviles, A. Garcia-Saavedra, M. Gramaglia, X. Costa-Perez, P. Serrano, and A. Banchs, “Nuberu: Reliable RAN Virtualization in Shared Platforms,” in Proc. of ACM MobiCom, October 2021.
[10] A. Garcia-Saavedra, X. Costa-Perez, D. J. Leith, and G. Iosifidis, “FluidRAN: Optimized vRAN/MEC Orchestration,” in Proc. of IEEE INFOCOM, April 2018.
[11] I. Parvez, A. Rahmati, I. Guvenc, A. I. Sarwat, and H. Dai, “A Survey on Low Latency Towards 5G: RAN, Core Network and Caching Solutions,” IEEE Communications Surveys & Tutorials, vol. 20, no. 4, 2018.
[12] F. Giannone, K. Kondepu, H. Gupta, F. Civerchia, P. Castoldi, A. Antony Franklin, and L. Valcarenghi, “Impact of Virtualization Technologies on Virtualized RAN Midhaul Latency Budget: A Quantitative Experimental Evaluation,” IEEE Communications Letters, vol. 23, no. 4, pp. 604-607, April 2019.
[13] M. Polese, R. Jana, V. Kounev, K. Zhang, S. Deb, and M. Zorzi, “Machine Learning at the Edge: A Data-Driven Architecture With Applications to 5G Cellular Networks,” IEEE Transactions on Mobile Computing, vol. 20, no. 12, pp. 3367-3382, December 2021.
[14] L. M. Vaquero, L. Rodero-Merino, and R. Buyya, “Dynamically Scaling Applications in the Cloud,” SIGCOMM Compututer Communication Review, vol. 41, no. 1, p. 45-52, January 2011.
[15] A. Bauer, V. Lesch, L. Versluis, A. Ilyushkin, N. Herbst, and S. Kounev, “Chamulteon: Coordinated Auto-Scaling of Micro-Services,” in Proc. of IEEE ICDCS, July 2019.
[16] A. Gulati, G. Shanmuganathan, A. Holler, and I. Ahmad, “Cloud Scale Resource Management: Challenges and Techniques,” in Proc. of USENIX HotCloud, 2011.
[17] A. Singhvi, A. Balasubramanian, K. Houck, M. D. Shaikh, S. Venkataraman, and A. Akella, “Atoll: A Scalable Low-Latency Serverless Platform,” in Proc. of ACM Symposium on Cloud Computing, 2021.
[18] T. Hu and Y. Wang, “A Kubernetes Autoscaler Based on Pod Replicas Prediction,” in Asia-Pacific Conference on Communications Technology and Computer Science (ACCTCS), January 2021, pp. 238-241.
[19] F. Rossi, M. Nardelli, and V. Cardellini, “Horizontal and Vertical Scaling of Container-Based Applications Using Reinforcement Learning,” in Proc. of IEEE CLOUD, July 2019.
[20] E. Casalicchio and V. Perciballi, “Auto-Scaling of Containers: The Impact of Relative and Absolute Metrics,” in Proc. of IEEE FAS*W, 2017.
[21] L. Abeni and D. Faggioli, “Using Xen and KVM as Real-time Hypervisors,” Journal of Systems Architecture, vol. 106, p. 101709, 2020.
[22] A. Di Stefano, A. Di Stefano, and G. Morana, “Ananke: A Framework for Cloud-Native Applications Smart Orchestration,” in Proc. of IEEE WETICE, 2020.
[23] I. Prachitmutita, W. Aittinonmongkol, N. Pojjanasuksakul, M. Supattatham, and P. Padungweang, “Auto-scaling Microservices on IaaS Under SLA with Cost-effective Framework,” in Proc. of IEEE ICACI, 2018.
[24] R. Han, L. Guo, M. M. Ghanem, and Y. Guo, “Lightweight Resource Scaling for Cloud Applications,” in Proc. of IEEE/ACM CCGrid, 2012.
[25] Kubernetes, “Horizontal Pod Autoscaling,” 2023. [Online]. Available: https://tinyurl.com/5n8jykm3
[26] M. Mao, J. Li, and M. Humphrey, “Cloud Auto-scaling with Deadline and Budget Constraints,” in 11th IEEE/ACM International Conference on Grid Computing, 2010.
[27] M. Mao and M. Humphrey, “Auto-Scaling to Minimize Cost and Meet Application Deadlines in Cloud Workflows,” in Proc. of 2011 International Conference for High Performance Computing, Networking, Storage and Analysis, 2011.
[28] A. Anagnostou, S. J. E. Taylor, N. Tijjani Abubakar, T. Kiss, J. DesLauriers, G. Gesmier, G. Terstyanszky, P. Kacsuk, and J. Kovacs, “Towards a Deadline-Based Simulation Experimentation Framework Using MicroServices Auto-Scaling Approach,” in Proc. of IEEE WSC, 2019.
[29] S. Das, F. Li, V. R. Narasayya, and A. C. Ko*nig, “Automated demand-driven resource scaling in relational database-as-a-service,” in Proc. ACM International Conference on Management of Data, 2016.
[30] M. Hoffmann and M. Dryjan'ski, “The O-RAN Whitepaper 2023: Energy Efficiency in O-RAN,” Rimedo Labs White Paper. [Online]. Available: https://tinyurl.com/ys7mmk69
[31] X. Fei, F. Liu, H. Xu, and H. Jin, “Adaptive VNF Scaling and Flow Routing with Proactive Demand Prediction,” in Proc. of IEEE INFOCOM, April 2018.
[32] Y. Bi, C. Colman-Meixner, R. Wang, F. Meng, R. Nejabati, and D. Simeonidou, “Resource Allocation for Ultra-Low Latency Virtual Network Services in Hierarchical 5G Network,” in Proc. of IEEE ICC, 2019.
[33] D. Harutyunyan, R. Behravesh, and N. Slamnik-Krijes ̌torac, “Cost-efficient Placement and Scaling of 5G Core Network and MEC-enabled Application VNFs,” in IFIP/IEEE International Symposium on Integrated Network Management (IM), 2021.
[34] K. Ali and M. Jammal, “Proactive VNF Scaling and Placement in 5G O-RAN using ML,” IEEE Transactions on Network and Service Management, 2023.
[35] S. D'Oro, L. Bonati, M. Polese, and T. Melodia, “OrchestRAN: Network Automation through Orchestrated Intelligence in the Open RAN,” in Proc. of IEEE INFOCOM, May 2022.
[36] J. Thaliath, S. Niknam, S. Singh, R. Banerji, N. Saxena, H. S. Dhillon, J. H. Reed, A. K. Bashir, A. Bhat, and A. Roy, “Predictive Closed-Loop Service Automation in O-RAN Based Network Slicing,” IEEE Communications Standards Magazine, vol. 6, no. 3, pp. 8-14, September 2022.
[37] A. Capone, S. D'Elia, I. Filippini, A. E. C. Redondi, and M. Zangani, “Modeling energy consumption of mobile radio networks: An operator perspective,” IEEE Wireless Communications, vol. 24, no. 4, 2017.
[38] J. A. Ayala-Romero, I. Khalid, A. Garcia-Saavedra, X. Costa-Perez, and G. Iosifidis, “Experimental Evaluation of Power Consumption in Virtualized Base Stations,” in Proc. of IEEE ICC, 2021.
[39] T. Pamuklu, S. Mollahasani, and M. Erol-Kantarci, “Energy-Efficient and Delay-Guaranteed Joint Resource Allocation and DU Selection in O-RAN,” in Proc. of IEEE 5GWF, October 2021.
[40] L. Bonati, S. D'Oro, L. Bertizzolo, E. Demirors, Z. Guan, S. Basagni, and T. Melodia, “CellOS: Zero-touch Softwarized Open Cellular Networks,” Computer Networks, vol. 180, pp. 1-13, October 2020.
[41] “Installation of the OSC Near-real-time RIC,” https://shorturl.at/sv135.
[42] M. Polese, L. Bonati, S. D'Oro, S. Basagni, and T. Melodia, “ColO-RAN: Developing Machine Learning-based xApps for Open RAN Closed-loop Control on Programmable Experimental Platforms,” IEEE Transactions on Mobile Computing, pp. 1-14, July 2022.
[43] J. G. Dunham, “Optimum Uniform Piecewise Linear Approximation of Planar Curves,” IEEE Transactions on Pattern Analysis and Machine Intelligence, no. 1, pp. 67-75, 1986.
[44] E. Vieth, “Fitting piecewise linear regression functions to biological responses,” Journal of applied physiology, vol. 67, no. 1, 1989.
[45] S. U. Ngueveu, “Piecewise Linear Bounding of Univariate Nonlinear Functions and Resulting Mixed Integer Linear Programming-based Solution Methods,” European Journal of Operational Research, vol. 275, no. 3, pp. 1058-1071, 2019.
[46] X. Fan, W.-D. Weber, and L. A. Barroso, “Power Provisioning for a Warehouse-sized Computer,” ACM SIGARCH Computer Architecture News, vol. 35, no. 2, pp. 13-23, 2007.
[47] M. Klimm, M. E. Pfetsch, R. Raber, and M. Skutella, “Packing under convex quadratic constraints,” Mathematical Programming, vol. 192, no. 1-2, pp. 361-386, 2022.
[48] C. Baskin, N. Liss, E. Zheltonozhskii, A. M. Bronstein, and A. Mendelson, “Streaming Architecture for Large-scale Quantized Neural Networks on an FPGA-based Dataflow Platform,” in Proc. of IEEE IPDPSW, 2018.

What is claimed is:

1. A method for energy aware wireless network intelligence scaling in an O-RAN open radio access network (RAN) comprising:
receiving, at an energy aware scaling Service Management and Orchestration (SMO) component (scaling component) deployed on a non-real-time (non-RT) RAN intelligent controller (RIC) of the O-RAN, a set of requests including a requested selection of apps comprising one or more rApps, xApps, dApps, or combinations thereof, each being a micro-service embedding an intelligent workload, for deployment on one or more server resources of the O-RAN, each rApp, xApp, and dApp having a maximum tolerable inference time associated therewith;
detecting, in the scaling component, a set of available server resources for executing the requested selection of apps;
determining an estimated inference time for each of the apps of the requested selection of apps;
generating, by an optimization engine of the scaling component, a deployment and instantiation policy (instantiation policy) for executing the requested selection of apps within the associated maximum tolerable inference times using the set of available server resources, the instantiation policy optimized to at least one of minimize energy consumption, maximize profitability, or both in connection with executing the requested selection of apps within the associated maximum tolerable inference times; and
deploying and instantiating, by a deployment engine of the scaling component, the requested selection of apps in the set of available server resources according to the instantiation policy to satisfy the set of requests.

2. The method of claim 1, wherein:
the maximum tolerable inference time for each rApp is 1 s or more;
the maximum tolerable inference time for each xApp is 1 s or less; and
the maximum tolerable inference time for each dApp is 10 ms or less.

3. The method of claim 1, wherein one or more of the rApps, xApps, and dApps of the requested selection of apps is selected from an app catalog stored in the non-RT RIC.

4. The method of claim 3, wherein a descriptor database in communication with the app catalog and the scaling component includes the estimated inference time associated with each of the one or more of the rApps, xApps, and dApps selected from the app catalog.

5. The method of claim 1, wherein one or more of the rApps, xApps, and dApps of the requested selection of apps is a new app provided by a request originator, not described in an app catalog stored in the non-RT RIC and not described in a descriptor database in communication with the app catalog and the scaling component.

6. The method of claim 5, the step of determining an estimated inference time further comprising profiling the new app by deploying the new app on an idle worker node of the O-RAN to benchmark the estimated inference time for the new app.

7. The method of claim 6, further comprising storing the estimated inference time for the new app in the descriptor database.

8. The method of claim 1, wherein the step of deploying and instantiating further comprises:
deploying and instantiating the rApps for execution in one or more non-RT RICs of the O-RAN;
deploying and instantiating the xApps for execution in one or more near-RT RICs of the O-RAN; and
deploying and instantiating the dApps for execution in one or more centralized units (CUs) and/or distributed units (DUs) of the O-RAN.

9. The method of claim 1, further comprising receiving, at the scaling component, a report from one or more of the server resources indicating a runtime latency associated therewith.

10. The method of claim 1, further comprising rejecting, by the optimization engine of the scaling component, any request of the set of requests that cannot be satisfied within the associated maximum tolerable inference time.

11. A system for energy aware wireless network intelligence scaling in an O-RAN open radio access network (RAN) comprising:
a set of available server resources of the O-RAN;
an energy aware scaling Service Management and Orchestration (SMO) component (scaling component) deployed in a non-real-time (non-RT) RAN intelligent controller (RIC) of the O-RAN, the scaling component configured to receive a set of requests including a requested selection of apps comprising one or more rApps, xApps, dApps, or combinations thereof, each being a micro-service embedding an intelligent workload, for deployment on one or more of the available server resources, each rApp, xApp, and dApp having a maximum tolerable inference time associated therewith; and
an optimization engine of the scaling component configured to execute instructions stored in the non-RT RIC that, when executed by the optimization engine, cause the scaling component to:
determine an estimated inference time for each of the apps of the requested selection of apps; and
generate a deployment and instantiation policy (instantiation policy) for executing the requested selection of apps within the associated maximum tolerable inference times using the set of available server resources, the instantiation policy optimized to at least one of minimize energy consumption; maximize profitability, or both in connection with executing the requested selection of apps within the associated maximum tolerable inference times; and
a deployment engine of the scaling component configured to execute instructions stored in the non-RT RIC that, when executed by the deployment engine, cause the scaling component to deploy and instantiate the requested selection of apps in the set of available server resources according to the instantiation policy to satisfy the set of requests.

12. The system of claim 11, wherein:
the maximum tolerable inference time for each rApp is 1 s or more;
the maximum tolerable inference time for each xApp is 1 s or less; and
the maximum tolerable inference time for each dApp is 10 ms or less.

13. The system of claim 11, wherein one or more of the rApps, xApps, and dApps of the requested selection of apps is selected from an app catalog stored in the non-RT RIC.

14. The system of claim 13, wherein a descriptor database in communication with the app catalog and the scaling component includes the estimated inference time associated with each of the one or more of the rApps, xApps, and dApps selected from the app catalog.

15. The system of claim 11, wherein one or more of the rApps, xApps, and dApps of the requested selection of apps is a new app provided by a request originator, not described in an app catalog stored in the non-RT RIC and not described in a descriptor database in communication with the app catalog and the scaling component.

16. The system of claim 15, further comprising an idle worker node of the O-RAN configured to benchmark the estimated inference time for the new app responsive to deployment of the new app to the idle worker node by the deployment engine according to instructions from the optimization engine.

17. The system of claim 16, wherein the idle worker node is configured to report the benchmarked estimated inference time for the new app to the scaling component for storage in the descriptor database.

18. The system of claim 11, further comprising:
one or more Non-Real-Time (non-RT) RICs of the O-RAN configured for deployment and instantiation of at least one of the rApps of the requested selection of apps for execution therein;
one or more near-RT RICs of the O-RAN configured for deployment and instantiation of at least one of the xApps of the requested selection of apps for execution therein;
one or more centralized units (CUs) and/or distributed units (DUs) of the O-RAN configured for deployment and instantiation of at least one of the dApps of the requested selection of apps for execution therein; or
combinations thereof.

19. The system of claim 11, the scaling component configured to receive a report from one or more of the server resources indicating a runtime latency associated therewith.

20. The system of claim 11, the optimization engine of the scaling component configured to execute instructions stored in the non-RT RIC that, when executed by the optimization engine, cause the scaling component to reject any request of the set of requests that cannot be satisfied within the associated maximum tolerable inference time.
